(19) United States
(12) Patent Application Publication
(10) Pub. No.: US 2014/0149623 A1
(43) Pub. Date: May 29, 2014

(54) INFORMATION PROCESSING APPARATUS AND CONTROL METHOD

(71) Applicant: Fujitsu Mobile Communications Limited, Kawasaki-shi (JP)

(72) Inventor: Takafumi NAKAMURA, Kawasaki (JP)

(73) Assignee: Fujitsu Mobile communications Limited, Kawasaki-shi (JP)

(21) Appl. No.: 14/034,663

(22) Filed: Sep. 24, 2013

(30) Foreign Application Priority Data
Nov. 28, 2012 (JP) 2012-259403

(51) Int. Cl. G06F 13/24

(52) U.S. Cl. CPC G06F 13/24
USPC 710/267

(57) ABSTRACT

A disclosed information processing apparatus includes: a first processing unit; and a second processing unit that is in either of an operational state and a suspended state. The first processing unit and the second processing unit are coupled by a first signal line through which a first signal that represents a state of the second processing unit passes and by a second signal line through which a second signal that causes an interrupt to the second processing unit passes. The second processing unit outputs the first signal according to a state of the second processing unit. The first processing unit determines, based on the first signal, whether the first processing unit causes the second processing unit to resume. When the first processing unit causes the second processing unit to resume, the first processing unit outputs the second signal, and the second processing unit resumes, upon receiving the second signal.

### CROSS-REFERENCE TO RELATED APPLICATIONS

This application is based upon and claims the benefit of priority of the prior Japanese Patent Application No. 2012-259403, filed on Nov. 28, 2012, the entire contents of which are incorporated herein by reference.

### FIELD

This technique relates to a control technique of plural arithmetic units (or processing units).

### BACKGROUND

For example, there are wireless phones that have high performance by using plural Central Processing Units (CPUs) such as a modem-side CPU that mainly performs wireless communication and application-side CPU that executes an application program and a display processing.

In such wireless phones, the application-side CPU is resumed from a suspended state to an operational state by an interrupt by the modem-side CPU. The application-side CPU has an input terminal to receive an interrupt signal from the modem-side CPU.

When a phone call or e-mail arrives, the application-side CPU is resumed by the interrupt by the modem-side CPU to the operational state. Then, the resumed application-side CPU receives notification of the incoming call or the like, and executes a processing of an application corresponding to the incoming call etc.

Moreover, in addition to the incoming call etc, in response to notification from the modem-side CPU, the application-side CPU executes a processing of an application. For example, in case of receiving notification of Received Signal Strength Indication (RSSI), the application-side CPU executes a processing of an application. RSSI represents strength of received signals, and is measured periodically. The application-side CPU displays a mark representing receiving strength according to the measured RSSI.

As for an application for the aforementioned RSSI, the modem-side CPU operates according to a state of the application-side CPU. In case where the application-side CPU is in an operational state, the modem-side CPU notifies the application-side CPU of RSSI, and the application-side CPU executes a processing of an application according to the notification of RSSI.

On the other hand, if the processing of the application regarding RSSI is not performed in case where the application-side CPU is in a suspended state, the modem-side CPU may not notify the application-side CPU of RSSI.

Thus, in an information processing apparatus having plural CPUs, one CPU may operate according to a state of the other CPU. In such a case, by an operation to notify one CPU of the state of the other CPU, the information processing apparatus consumes the power.

In other words, there is no conventional technique to effectively suppress the power consumption relating to operations executed by plural arithmetic units or processing units included in the information processing apparatus.

### SUMMARY

An information processing apparatus relating to a first aspect of this technique includes: a first processing unit; and a second processing unit that is in either of an operational state and a suspended state. The first processing unit and the second processing unit are coupled each other by a first signal line through which a first signal that represents a state of the second processing unit passes and by a second signal line through which a second signal that causes an interrupt to the second processing unit passes. Then, the second processing unit outputs the first signal through the first signal line according to a state of the second processing unit. The first processing unit determines, based on the first signal received through the first signal line, whether or not the first processing unit causes the second processing unit to resume to the operational state, and upon determining that the first processing unit causes the second processing unit to resume to the operational state, the first processing unit outputs the second signal through the second signal line. The second processing unit resumes to the operational state, upon receiving the second signal through the second signal line.

An information processing apparatus relating to a second aspect of this technique includes: a first processing unit; a second processing unit that is in either of an operational state and a suspended state; and a measurement device that measures an input current to the second processing unit and determines a state of the second processing unit. The first processing unit and the second processing unit are coupled each other by a signal line through which an interrupt signal to the second processing unit passes. Then, the first processing unit obtains a state of the second processing unit from the measurement device, and determines, based on the obtained state of the second processing unit, whether or not the first processing unit causes the second processing unit to resume to the operational state. Upon determining that the first processing unit causes the second processing unit to resume to the operational state, the first processing unit outputs the interrupt signal through the signal line. The second processing unit resumes to the operational state in response to receipt of the interrupt signal from the signal line.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a hardware configuration example of a communication apparatus;

FIG. 2 is a diagram depicting a state transition at resume and stop of the application-side CPU in an example;

FIG. 3 is a diagram depicting a state transition when an incoming call event occurs in the example;

FIG. 4 is a diagram depicting a state transition when an RSSI event occurs in the example;

FIG. 5 is a diagram depicting a state transition when the RSSI event occurs in the example;

FIG. 6 is a diagram depicting a hardware configuration example of a communication apparatus in a first embodiment;

FIG. 7 is a diagram depicting a state transition at the resume and stop of the application-side CPU in the first embodiment;

FIG. 8 is a diagram depicting a state transition when the incoming call event occurs in the first embodiment;

FIG. 9 is a diagram depicting a state transition when the RSSI event occurs in the first embodiment;

FIG. 10 is a diagram depicting a state transition when the RSSI event occurs in the first embodiment;

FIG. 11 is a diagram depicting a sequence at the resume and stop of the application-side CPU in the first embodiment;

FIG. 12A is a diagram depicting a sequence when the incoming call event occurs in the first embodiment;

FIG. 12B is a diagram depicting a sequence when the incoming call event occurs in the first embodiment;

FIG. 12C is a diagram depicting a sequence when the incoming call event occurs in the first embodiment;

FIG. 13A is a diagram depicting a sequence when the RSSI event occurs in the first embodiment;

FIG. 13B is a diagram depicting a sequence when the RSSI event occurs in the first embodiment;

FIG. 13C is a diagram depicting a sequence when the RSSI event occurs in the first embodiment;

FIG. 14 is a diagram depicting a sequence when the RSSI event occurs in the first embodiment;

FIG. 15 is a diagram depicting a processing flow of a main controller of a modem-side system in the first embodiment;

FIG. 16 is a diagram depicting a flow of a first determination processing;

FIG. 17 is a diagram depicting a flow of a first modem-side resume processing;

FIG. 18 is a diagram depicting a flow of a modem-side connection processing;

FIG. 19 is a diagram depicting a flow of a first modem-side disconnection processing;

FIG. 20 is a diagram depicting a processing flow of a main controller of an application-side system in the first embodiment;

FIG. 21 is a diagram depicting a flow of a first application-side resume processing;

FIG. 22 is a diagram depicting a flow of an application-side connection processing;

FIG. 23 is a diagram depicting a flow of a first application-side disconnection processing;

FIG. 24 is a diagram depicting a state transition at the resume and stop of the application-side CPU in a second embodiment;

FIG. 25 is a diagram depicting a state transition when the incoming call event occurs in the second embodiment;

FIG. 26 is a diagram depicting a state transition when the RSSI event occurs in the second embodiment;

FIG. 27 is a diagram depicting a state transition when the RSSI event occurs in the second embodiment;

FIG. 28 is a diagram depicting a sequence at the resume and stop of the application-side CPU in the second embodiment;

FIG. 29A is a diagram depicting a sequence when the incoming call event occurs in the second embodiment;

FIG. 29B is a diagram depicting a sequence when the incoming call event occurs in the second embodiment;

FIG. 30A is a diagram depicting a sequence when the RSSI event occurs in the second embodiment;

FIG. 30B is a diagram depicting a sequence when the RSSI event occurs in the second embodiment;

FIG. 31 is a diagram depicting a sequence when the RSSI event occurs in the second embodiment;

FIG. 32 is a diagram depicting a processing flow of the main controller of the modem-side system in the second embodiment;

FIG. 33 is a diagram depicting a flow of a second determination processing;

FIG. 34 is a diagram depicting a flow of a second modem-side resume processing;

FIG. 35 is a diagram depicting a flow of a second modem-side disconnection processing;

FIG. 36 is a diagram depicting a processing flow of the main controller of the application-side system in the second embodiment;

FIG. 37 is a diagram depicting a flow of a second application-side resume processing;

FIG. 38 is a diagram depicting a flow of a second application-side disconnection processing;

FIG. 39 is a diagram depicting a hardware configuration example of a communication apparatus in a third embodiment;

FIG. 40A is a diagram depicting a sequence when the incoming call event occurs in the third embodiment;

FIG. 40B is a diagram depicting a sequence when the incoming call event occurs in the third embodiment;

FIG. 41A is a diagram depicting a sequence when the RSSI event occurs in the third embodiment;

FIG. 41B is a diagram depicting a sequence when the RSSI event occurs in the third embodiment;

FIG. 42 is a diagram depicting a sequence when the RSSI event occurs in the third embodiment;

FIG. 43 is a diagram depicting a processing flow of a main controller of a modem-side system in the third embodiment;

FIG. 44 is a diagram depicting a flow of a third determination processing;

FIG. 45 is a diagram depicting a flow of a third modem-side resume processing;

FIG. 46 is a diagram depicting a flow of a third modem-side disconnection processing;

FIG. 47 is a diagram depicting a processing flow of a main controller of a modem-side system in the third embodiment;

FIG. 48 is a diagram depicting a flow of a third application-side resume processing; and

FIG. 49 is a diagram depicting a flow of a third application-side disconnection processing.

### DESCRIPTION OF EMBODIMENTS

### Embodiment 1

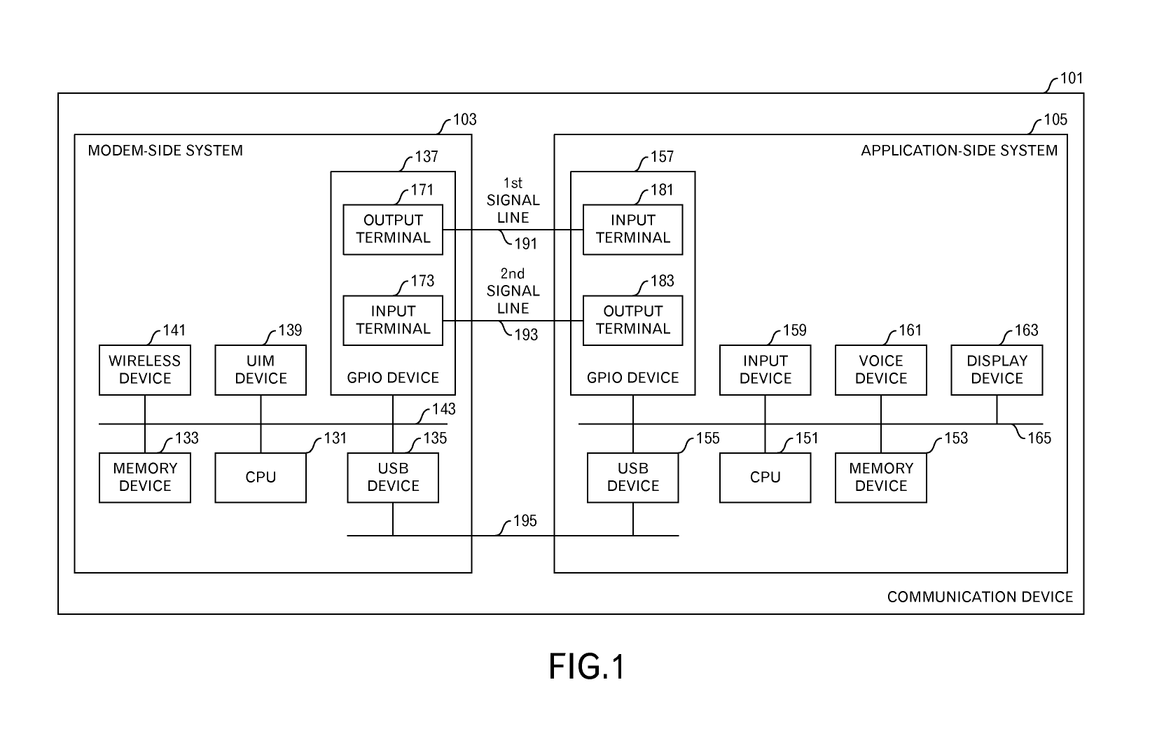

First, a comparative example of a communication apparatus that has plural CPUs will be explained. FIG. 1 illustrates an example of a hardware configuration of a communication apparatus 101. In this example, the communication apparatus 101 has a modem-side system 103 and an application-side system 105.

The modem-side system 103 is a system for mainly performing wireless communication. The modem-side system 103 has a CPU 131, memory device 133, Universal Serial Bus (USB) device 135, General Purpose Input/Output (GPIO) device 137, User Identity Module (UIM) device 139 and wireless device 141. The CPU 131, memory device 133, USB device 135, GPIO device 137, UIM device 139 and wireless device 141 are connected through a bus 143.

The CPU 131 executes a program for mainly performing wireless communication. The memory device 133 stores the program for performing the wireless communication and data for the wireless communication. The USB device 135 performs data communication by USB. The GPIO device 137 has an input terminal 173 that receives a signal in response to an instruction of the program executed in the CPU 131 and an output terminal 171 that outputs a signal. The UIM device 139 controls a UIM card for identifying personal information of a user such as a telephone number of a portable phone. The wireless device 141 is used for the wireless communication such as the phone call or mail of the portable phone.

The application-side system 105 is a system to mainly execute an application program. The application-side system 105 has a CPU 151, memory device 153, USB device 155, GPIO device 157, input device 159, voice device 161 and display device 163. Moreover, the CPU 151, memory device 153, USB device 155, GPIO device 157, input device 159, voice device 161 and display device 163 are connected through a bus 165.

The CPU 151 mainly executes an application program. The memory device 153 stores the application program and data concerning the application program. The USB device 155 performs data communication by USB. The GPIO device 157 has an input terminal 181 that receives a signal in response to an instruction from the application program executed by the CPU 151, and an output terminal 183 that outputs a signal. The input device 159 receives an instruction from a user. The input device 159 is a set of keys or touch panel, for example. The voice device 161 performs an input or output of the voice. The display device 163 displays a screen image.

The USB device 135 of the modem-side system 103 and the USB device 155 of the application-side system 105 are connected through a serial bus 195 for performing data communication.

The output terminal 171 provided in the GPIO device 137 in the modem-side system 103 and the input terminal 181 provided in the GPIO device 157 in the application-side system 105 are connected through a first signal line 191. The first signal line 191 is mainly used to output an interrupt signal for resuming the CPU 151 in the application-side system 105 from the suspended state to the operational state from the CPU 131 of the modem-side system 103.

Moreover, the input terminal 173 provided in the GPIO device 137 in the modem-side system 103 and the output terminal 183 provided in the GPIO device 157 in the application-side system 105 are connected through a second signal line 193. The second signal line 193 is mainly used to output an interrupt signal for resuming the CPU 131 of the modem-side system 103 from the suspended state to the operational state from the CPU 151 of the application-side system 105.

In this comparative example, a state flag to manage, in the modem-side system 103, a state of the CPU 151 in the application-side system 105 is stored in the memory device 133. Then, when the CPU 151 in the application-side system 105 resumes from the suspended state to the operational state, the CPU 151 notifies the CPU 131 in the modem-side system 103 of its own resume. Then, the CPU 131 of the modem-side system 103 updates the state flag to “ON”.

Moreover, when the CPU 151 of the application-side system 105 stops and the state of the CPU 151 changes from the operational state to the suspended state, the CPU 151 notifies the CPU 131 of the modem-side system 103 of its own stop. Then, the CPU 131 of the modem-side system 103 updates the state flag to “OFF”. However, the stop in this case means stop of a part of functions in the CPU. Functions for the resume in response to the interrupt signal are operating even after they stopped once.

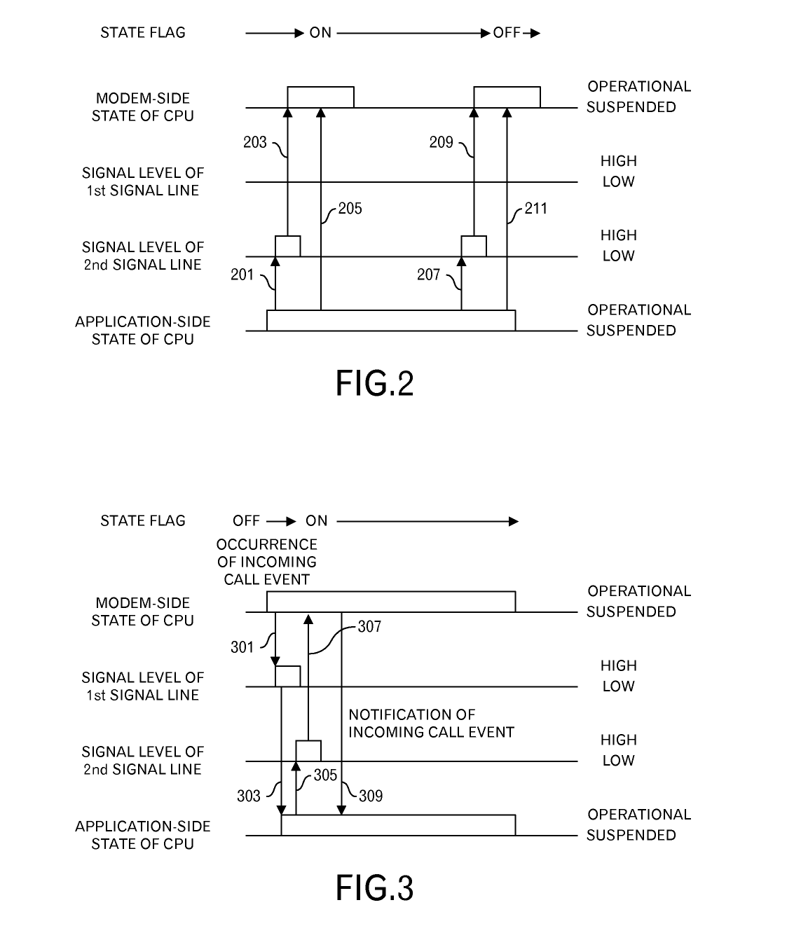

FIG. 2 illustrates a state transition at the resume and stop of the CPU 151 in the application-side system 105. The CPU 151 in the application-side system 105, which resumed to the operational state, switches a signal level of a second signal line 193 from LOW to HIGH (high level) as illustrated by an arrow 201. When the CPU 131 of the modem-side system 103 detects that the signal level of the second signal line 193 is HIGH as illustrated by an arrow 203, the CPU 131 resumes by itself. Thus, the state of the CPU 131 of the modem-side system 103 shifts from the suspended state to the operational state. Then, as illustrated by an arrow 205, the CPU 151 of the application-side system 105 notifies that the CPU 151 has resumed through a USB connection path 195. In response to the notification, the state flag of the modem-side system 103 is updated to “ON”. The state of the CPU 131 of the modem-side system 103 shifts to the suspended state again when there is no processing later.

On the other hand, when the state of the CPU 151 of the application-side system 105 shifts from the operational state to the suspended state by stopping the CPU 151, the CPU 151 of the application-side system 105 switches the signal level of the second signal line 193 from LOW (low level) to HIGH as illustrated by an arrow 207. When the CPU 131 of the modem-side system 103 detects the signal level of the second signal line 193 is HIGH as illustrated by an arrow 209, the CPU 131 resumes by itself. Thus, the state of the CPU 131 of the modem-side system 103 shifts from the suspended state to the operational state. Then, as illustrated by an arrow 211, the CPU 151 of the application-side system 105 notifies that the CPU 151 will stop through the USB connection path 195. Thus, the state flag of the modem-side system 103 is updated to “OFF”. The state of the CPU 131 of the modem-side system 103 shifts to the suspended state again, when there is no processing later. Then, the state of the CPU 151 of the application-side system 105 shifts from the operational state to the suspended state.

Next, an operation at the incoming call or the like will be explained. When receiving an incoming call, an application program will be executed even if the CPU 151 of the application-side system 105 is operating or being suspended. Therefore, the CPU 131 of the modem-side system 103 causes the CPU 151 of the application-side system 105 that is being suspended to resume to the operational state. However, when the CPU 151 of the application-side system 105 is operating and the CPU 151 receives an interrupt signal for the resume from the CPU 131 of the modem-side system 103, any particular processing is not performed because the CPU 151 has already resumed.

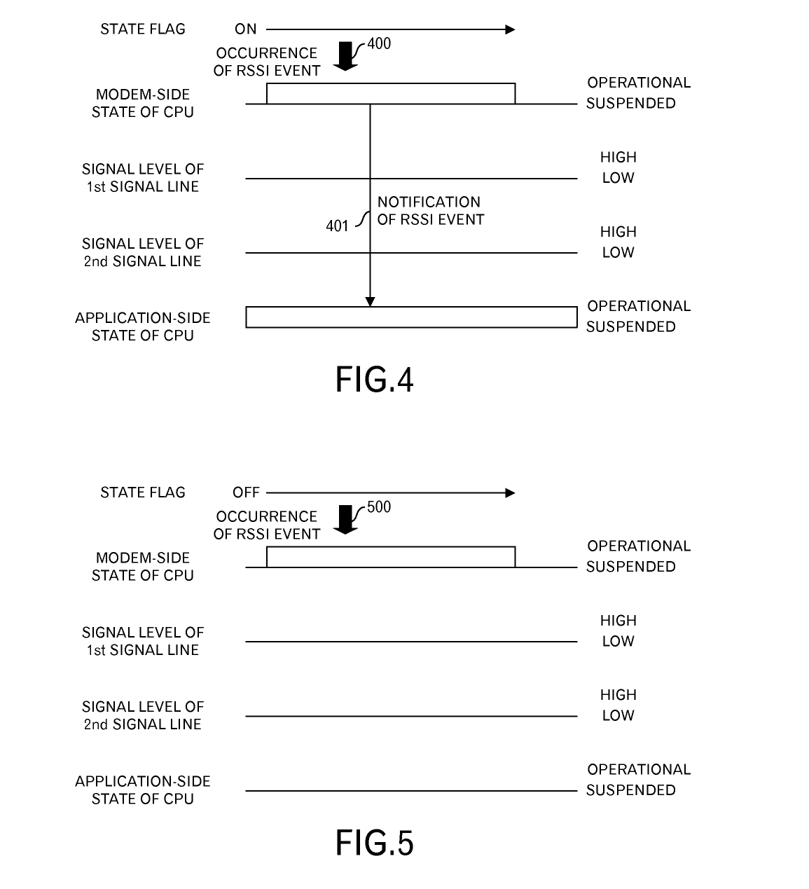

FIG. 3 illustrates a state transition when an incoming call event occurs in this comparative example will be explained. The incoming call event occurs when a connection request is received by the wireless device 141. When the incoming call event occurs in the modem-side system 103, the CPU 131 of the modem-side system 103 switches the signal level of the first signal line 191 from LOW to HIGH as illustrated by an arrow 301. When the CPU 151 of the application-side system 105 detects the signal level of the first signal line 191 is HIGH as illustrated by an arrow 303, the CPU 151 resumes by itself to the operational state. Then, as illustrated by an arrow 305, the CPU 151 of the application-side system 105 switches the signal level of the second line 193 from LOW to HIGH. As illustrated by an arrow 307, the CPU 131 of the modem-side system 103 detects the signal level of the second signal line 193 is HIGH, the CPU 131 has already resumed, so no processing is executed.

Then, as illustrated by an arrow 309, the CPU 131 of the modem-side system 103 notifies the CPU 151 of the application-side system 105 of the incoming call event through the USB connection path. After that, the CPU 151 of the application-side system 105 performs a processing of an application program according to the incoming call event.

Next, a case where a RSSI event occurs will be explained. The RSSI event occurs when the strength of the signal received by the wireless device 141 is measured. According to the measure RSSI value, display of a receiver sensitivity (e.g. radio field intensity) is made. For example, the receiver sensitivity is displayed on a screen of the display device 163. Only when the CPU 151 of the application-side system 105 is operating, the display of the receiver sensitivity is performed. When the CPU 151 of the application-side system 105 is suspended, the display of the receiver sensitivity is not performed. By controlling such a manner, wasteful power consumption is suppressed.

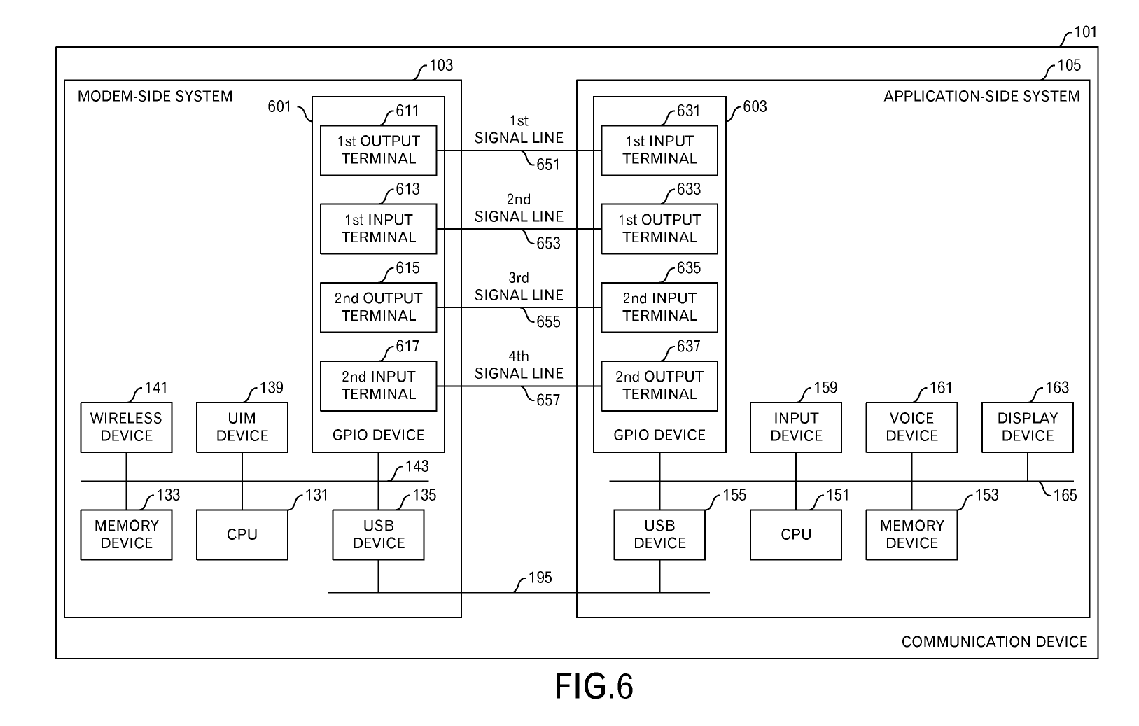

By using FIG. 4, a state transition when the RSSI event occurs in the operational state of the CPU 151 in the application-side system 105 will be explained. When the RSSI event occurs, the CPU 131 of the modem-side system 103 determines that the CPU 151 of the application-side system 105 is operating, based on the state flag “ON”, as illustrated by an arrow 400. Then, as illustrated by an arrow 401, the CPU 131 of the modem-side system 103 notifies the CPU 151 of the application-side system 105 of the RSSI event through the USB connection path. The CPU 151 of the application-side system 105 executes a processing of an application program according to the RSSI event.

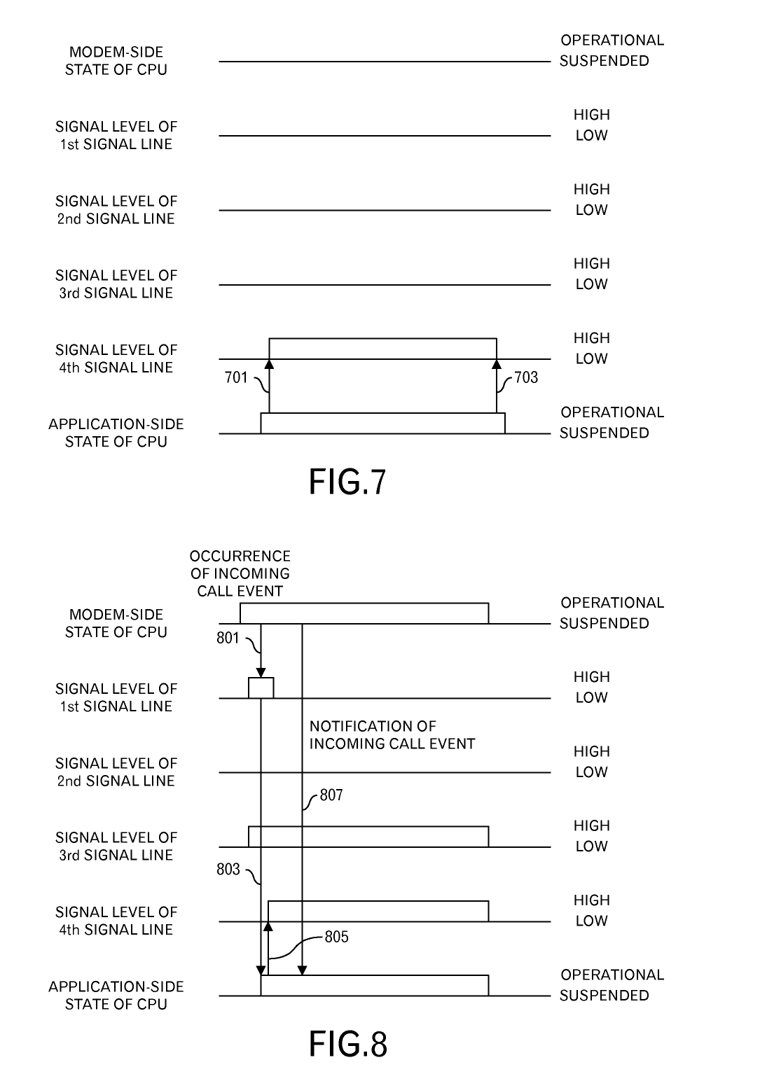

Next, by using FIG. 5, a state transition when the RSSI event occurs in the suspended state of the CPU 151 in the application-side system 105 will be explained. When the RSSI event occurs, the CPU 131 of the modem-side system 103 determines that the CPU 151 of the application-side system 105 is being suspended, based on the state flag “OFF”, as illustrated by an arrow 500. In this case, the notification of the RSSI event is not sent.

Thus, depending on a type of the event and the state of the CPU 151 in the application-side system 105, control is made so as to resume or so as not to resume the CPU 151 of the application-side system 105 by the CPU 131 of the modem-side system 103. Thus, it is possible to omit a wasteful operation to reduce the power consumption. However, in this comparative example, as illustrated in FIG. 2, each time when the CPU 151 of the application-side system 105 is resumed or stopped, the CPU 131 of the modem-side system 103 is resumed, so the power consumption increases. Next, this embodiment to further suppress the power consumption will be explained.

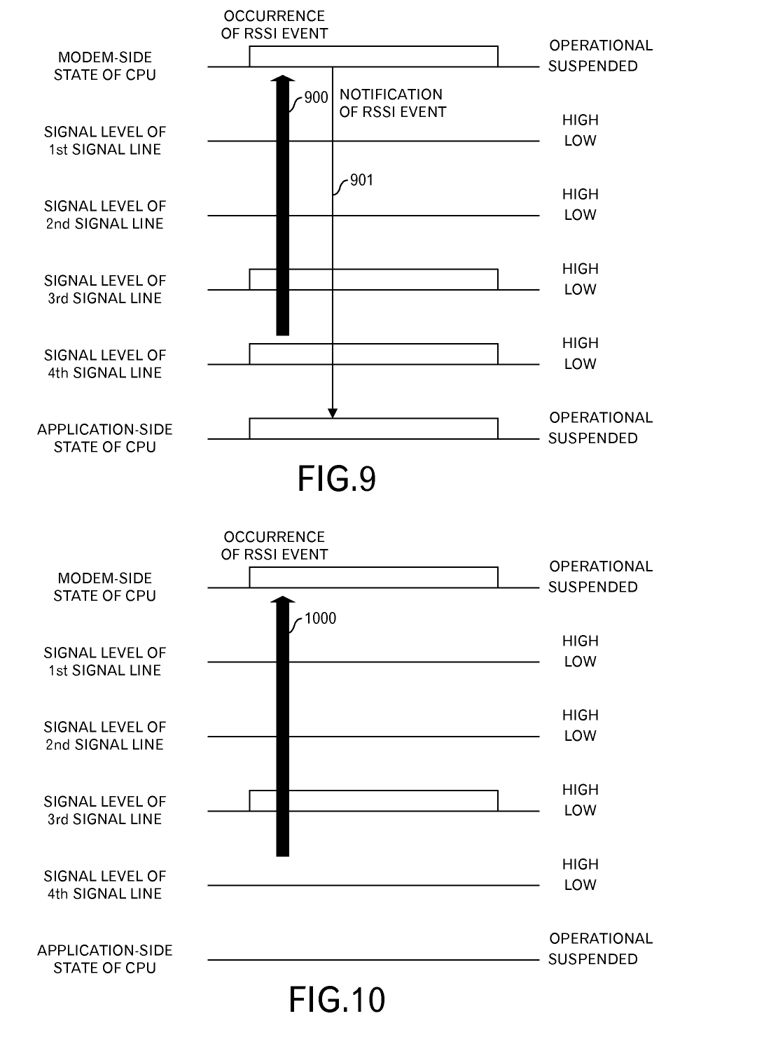

FIG. 6 illustrates a hardware configuration example of a communication apparatus in this embodiment. Similar to FIG. 1, the modem-side system 103 has a CPU 131, memory device 133, USB device 135, UIM device 139, wireless device 141 and bus 143. The modem-side system 103 has a GPIO device 601 instead of the GPIO device 137 illustrated in FIG. 1.

Similarly to FIG. 1, the application-side system 105 has the CPU 151, memory device 153, USB device 155, input device 159, voice device 161, display device 163 and bus 165. The application-side system 105 has a GPIO device 603 instead of the GPIO device 157 illustrated in FIG. 1.

The GPIO device 601 includes a first output terminal 611, first input terminal 613, second output terminal 615 and second input terminal 617. The GPIO device 603 includes a first input terminal 631, first output terminal 633, second input terminal 635 and second output terminal 637.

Then, the first output terminal 611 of the GPIO device 601 and the first input terminal 631 of the GPIO device 603 are connected through a first signal line 651. The first input terminal 613 of the GPIO device 601 and the first output terminal 633 of the GPIO device 603 are connected through a second signal line 653. The second output terminal 615 of the GPIO device 601 and the second input terminal 635 of the GPIO device 603 are connected through a third signal line 655. The second input terminal 617 of the GPIO device 601 and the second output terminal 637 of the GPIO device 603 are connected through a fourth signal line 657.

The first signal line 651 is mainly used to output an interrupt signal for resuming the CPU 151 of the application-side system 105 from the suspended state to the operational state. The second signal line 653 is mainly used to output an interrupt signal for resuming the CPU 131 of the modem-side system 103 from the suspended state to the operational state. The third signal line 655 is mainly used to output a signal representing a state of the CPU 131 of the modem-side system 103 to the CPU 151 of the application-side system 105. The fourth signal line 657 is mainly used to output a signal representing a state of the CPU 151 of the application-side system 105 to the CPU 131 of the modem-side system 103.

Thus, in this embodiment, in addition to a signal line to interrupt another CPU, a signal line to notify a state of its own CPU is provided. In the following, a state transition in this embodiment will be explained.

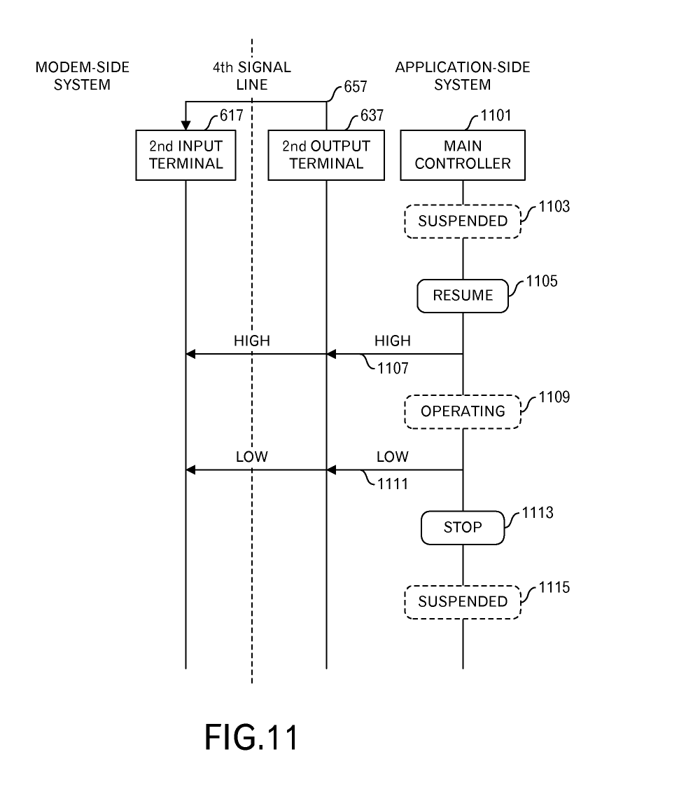

First, a state transition at the resume and stop of the CPU 151 in the application-side system 105 in this embodiment will be explained by using FIG. 7. When the CPU 151 of the application-side system 105 is resumed and the state shifts from the suspended state to the operational state, the CPU 151 of the application-side system 105 switches the signal level of the fourth signal line 657 from LOW to HIGH as illustrated by an arrow 701. Moreover, when the CPU 151 of the application-side system 105 is stopped and the state shifts from the operational state to the suspended state, the CPU 151 of the application-side system 105 switches the signal level of the fourth signal line 657 from HIGH to LOW as illustrated by an arrow 703.

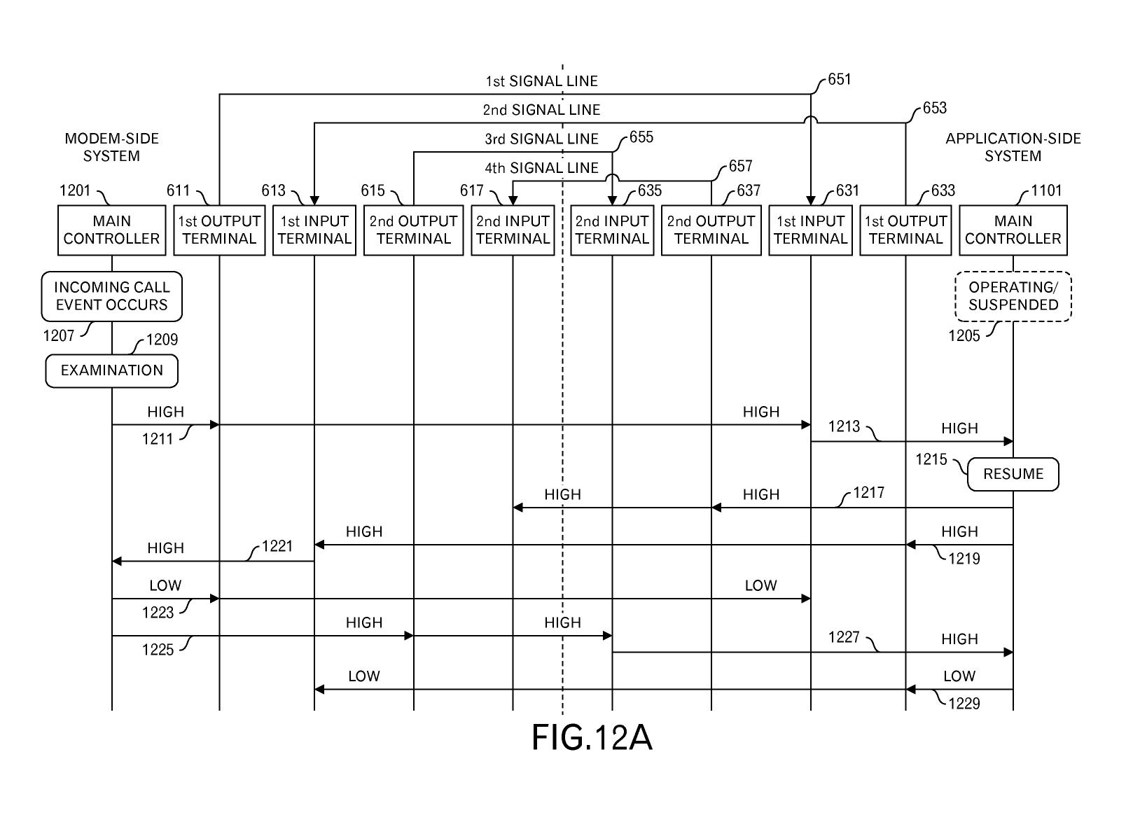

Next, a state transition when an incoming call event occurs in this embodiment will be explained by using FIG. 8. Similarly to the aforementioned comparative example, when receiving the incoming call, an application program is also executed in this embodiment even when the CPU 151 of the application-side system 105 is in the operational state or in the suspended state.

The incoming call event occurs when a connection request is received by the wireless device 141. When the incoming call event occurs in the modem-side system 103, the CPU 131 of the modem-side system 103 switches the signal level of the first signal line 651 from LOW to HIGH as illustrated by an arrow 801. When the CPU 151 of the application-side system 105 detects that the signal level of the first signal line 651 is HIGH as illustrated by an arrow 803, the CPU 151 returns to the operational state by itself. As illustrated by an arrow 805, the CPU 151 of the application-side system 105 switches the signal level of the fourth signal line 657 from LOW to HIGH. Thus, it is represented that the CPU 151 of the application-side system 105 is operating. Then, as illustrated by an arrow 807, the CPU 131 of the modem-side system 103 notifies the CPU 151 of the application-side system 105 of the incoming call event through the USB connection path. Then, the CPU 151 of the application-side system 105 executes a processing of an application program according to the incoming call event.

Next, a state transition when the RSSI event occurs in this embodiment will be explained. Similarly to the aforementioned example, only when the CPU 151 of the application-side system 105 is operating, the display of the receiver sensitivity is made. When the CPU 151 of the application-side system 105 is suspended, the display of the receiver sensitivity is not carried out.

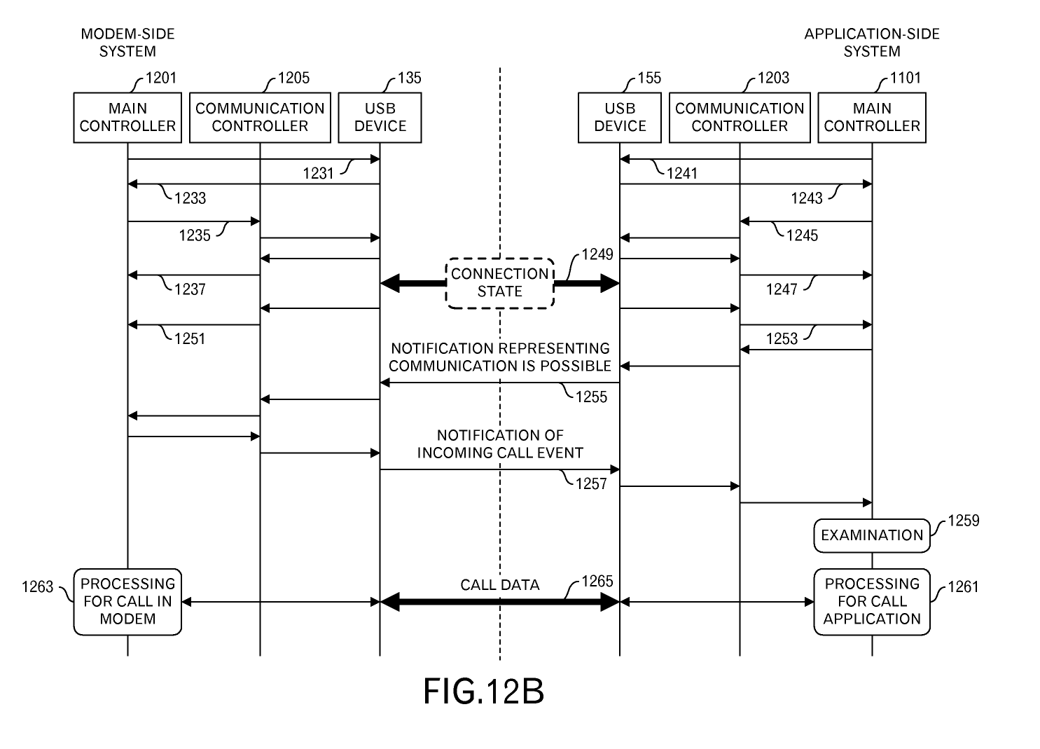

By using FIG. 9, a state transition when the RSSI event occurs in the operating state of the CPU 151 in the application-side system 105 will be explained. As illustrated by an arrow 900, the CPU 131 of the modem-side system 103 determines that the CPU 151 of the application-side system 105 is operating, because the fourth signal line 657 is HIGH. Then, as illustrated by an arrow 901, the CPU 131 of the modem-side system 103 notifies the CPU 151 of the application-side system 105 of the RSSI event through the USB connection path. After that, the CPU 151 of the application-side system 105 executes a processing of an application program according to the RSSI event.

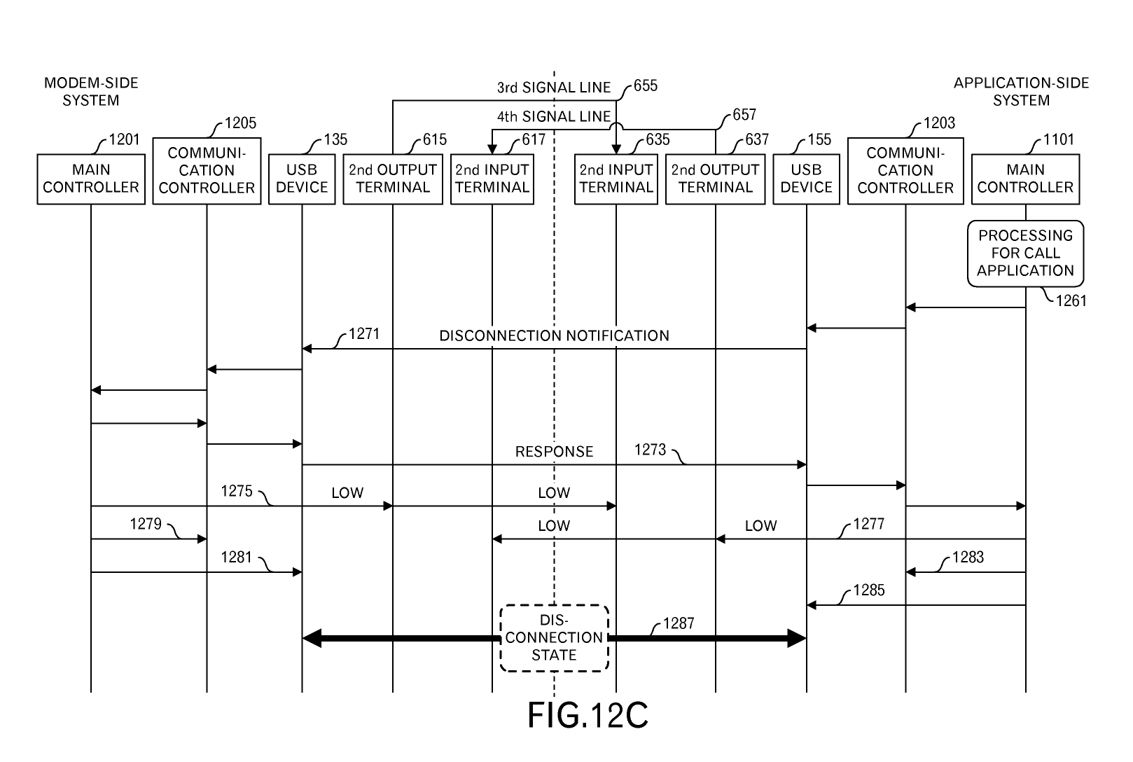

Next, a state transition when the RSSI event occurs in the suspended state of the CPU 151 in the application-side system 105 will be explained by using FIG. 10. When the RSSI event occurs, the CPU 131 of the modem-side system 103 determines that the CPU 151 of the application-side system 105 is suspended as illustrated by an arrow 1000, because the fourth signal line 657 is LOW. In this case, notification of the RSSI event is not made.

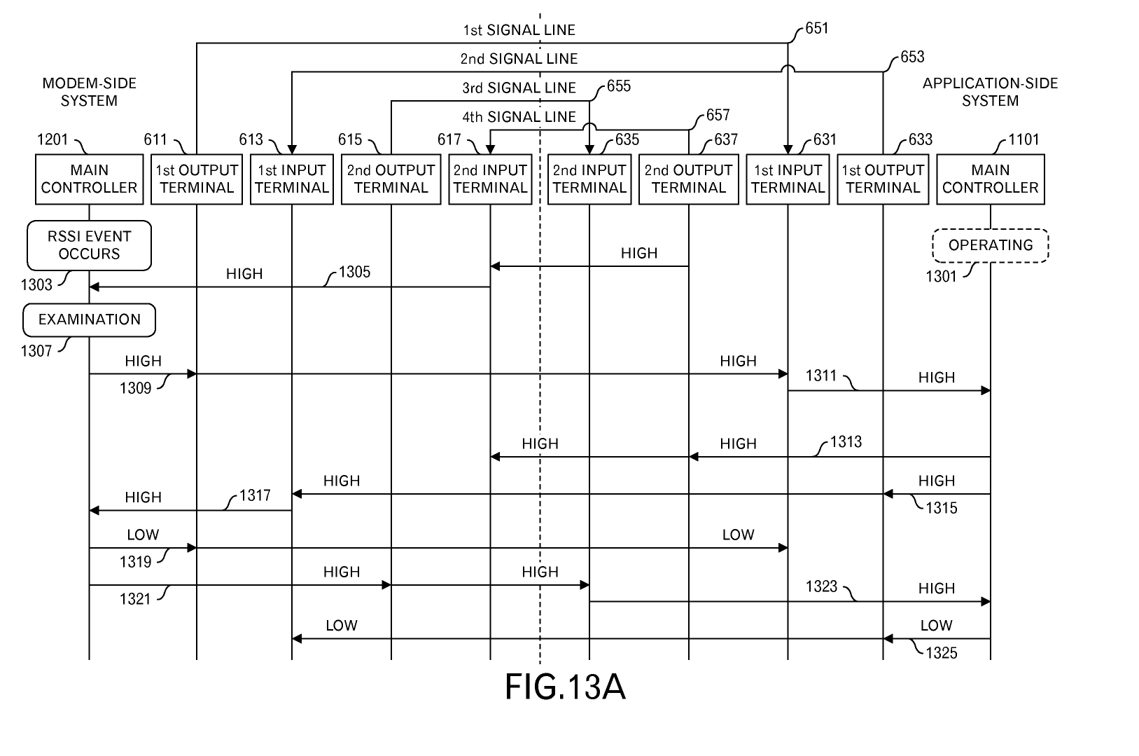

Next, sequences in this embodiment will be explained. First, a sequence at the resume and stop of the CPU 151 in the application-side system 105 in this embodiment will be explained by using FIG. 11. A main controller 1101 is achieved by executing program modules by the CPU 151 of the application-side system 105. The program modules to achieve the main controller 1101 is stored, for example, in the memory device 153, and CPU 151 reads out and executes instruction codes of the program modules in sequence.

It is assumed that the state of the CPU 151 in the application-side system 105 is suspended (1103). In response to an input of an interrupt signal or the like, the CPU 151 of the application-side system 105 is resumed (1105). Then, as illustrated by an arrow 1107, the main controller 1101 of the application-side system 105 switches the signal level of the fourth signal line 657 to HIGH through the second output terminal 637 of the application-side system 105. Thus, the state of the CPU 151 of the application-side system 105 shifts to the operational state (1109).

Moreover, when the main controller 1101 of the application-side system 105 stops by itself, the main controller 1101 switches the signal level of the fourth signal line 657 to LOW through the second output terminal 637 of the application-side system 105 as illustrated by an arrow 1111. Then, when the main controller 1101 of the application-side system 105 stops (1113), the state of the CPU 151 of the application-side system 105 shifts to the suspended state (1115). Thus, the state of the CPU 151 of the application-side system 105 reflects to the fourth signal line 657.

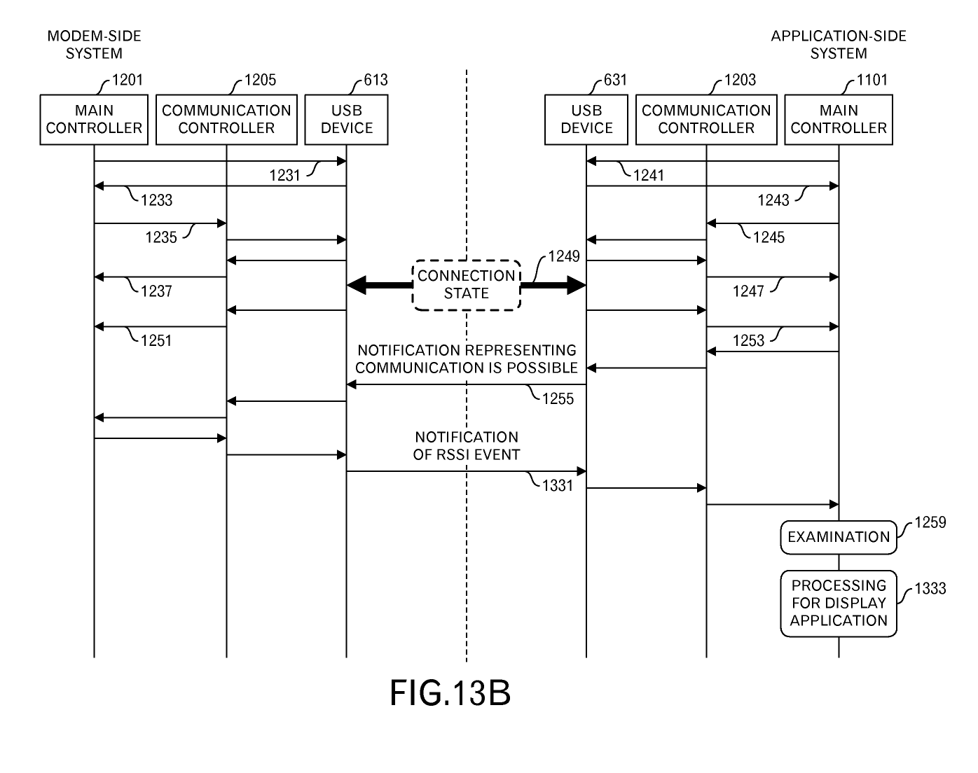

Next, a sequence when the incoming call event occurs in the first embodiment will be explained by using FIG. 12A. The main controller 1201 is achieved by executing program modules by the CPU 131 of the modem-side system 103. The program modules for achieving the main controller 1201 are stored, for example, in the memory device 133, and the CPU 131 reads out and executes instruction codes of the program modules in sequence.

It is assumed that the state of the CPU 151 of the application-side system 105 is the operational state or suspended state (1205). In case of the operational state or suspended state, the sequence is the same. The state of the CPU 131 of the modem-side system 103 is the operational state. When the incoming call event occurred (1207), the main controller 1201 of the modem-side system 103 examines the occurrence of the event (1209). Because the incoming call event occurred, it is determined that the notification of the examination result is required. In the following, a sequence when the event that occurred is the incoming call event will be explained.

As illustrated by an arrow 1211, the main controller 1201 of the modem-side system 103 switches the signal level of the first signal line 651 to HIGH through the first output terminal 611 of the modem-side system 103. This is an interrupt signal to resume the CPU 151 of the application-side system 105.

Then, as illustrated by an arrow 1213, when the main controller 1101 of the application-side system 105 detects that the signal level of the first signal line 651 is HIGH through the first input terminal 631 of the application-side system 105, the CPU 151 of the application-side system 105 is resumed (1215). However, when the CPU 151 has already been operating, no particular processing is executed.

As illustrated by an arrow 1217, the main controller 1101 of the application-side system 105 switches the signal level of the fourth signal line 657 to HIGH through the second output terminal 637 of the application-side system 105. Thus, it is represented that the CPU 151 of the application-side system 105 is operating.

As illustrated by an arrow 1219, the main controller 1101 of the application-side system 105 switches the signal level of the second signal line 653 to HIGH through the first output terminal 633 of the application-side system 105. This is an interrupt signal for the resume to the CPU 131 of the modem-side system 103, however, the CPU 131 of the modem-side system 103 is operating, so it is not substantially effective. This is a processing to surely perform the operation.

As illustrated by an arrow 1221, the main controller 1201 of the modem-side system 103 detects that the signal level of the second signal line 653 is HIGH through the first input terminal 613 of the modem-side system 103. However, no particular processing is carried out.

As illustrated by an arrow 1223, the main controller 1201 of the modem-side system 103 switches the signal level of the first signal line 651 to LOW through the first output terminal 611 of the modem-side system 103. Thus, the interrupt signal represented by the arrow 1211 is terminated.

As illustrated by an arrow 1225, the main controller 1201 of the modem-side system 103 switches the signal level of the third signal line 655 to HIGH through the second output terminal 615 of the modem-side system 103. Thus, it is represented that the CPU 131 of the modem-side system 103 is operating.

As illustrated by an arrow 1227, the main controller 1101 of the application-side system 105 detects that the signal level of the third signal line 655 is HIGH through the second input terminal 635 of the application-side system 105. Thus, it is determined that the CPU 131 of the modem-side system 103 is resumed, and as illustrated by an arrow 1229, the main controller 1101 of the application-side system 105 switches the signal level of the second signal line 653 to LOW through the first output terminal 633 of the application-side system 105. Thus, an interrupt signal outputted at a timing of the arrow 1219 is terminated.

Next, a next sequence to the sequence when the incoming call event occurs in this embodiment will be explained by using FIG. 12B.

The communication controller 1203 is realized by executing program modules by the CPU 151 of the application-side system 105. The program modules for realizing the communication controller 1203 are stored, for example, in the memory device 153, and the CPU 151 reads out and executes instruction codes for the program modules in sequence.

The communication controller 1205 is achieved by executing program modules by the CPU 131 of the modem-side system 103. The program modules for achieving the communication controller 1205 are stored, for example, in the memory device 133, and the CPU 131 reads out and executes instruction codes for the program modules in sequence.

As illustrated by an arrow 1231, the main controller 1201 of the modem-side system 103 activates the USB device 135 of the modem-side system 103. Then, as illustrated by an arrow 1233, the main controller 1201 of the modem-side system 103 receives an ACK (i.e. response) from the USB device 135 of the modem-side system 103.

As illustrated by an arrow 1235, the main controller 1201 of the modem-side system 103 resumes the communication controller 1205 of the modem-side system 103 from the suspended state to the operational state. The communication controller 1205 of the modem-side system 103 instructs the USB device 135 of the modem-side system 103 to start communication, and the communication controller 1205 of the modem-side system 103 receives an ACK from the USB device 135 of the modem-side system 103. As illustrated by an arrow 1237, the main controller 1201 of the modem-side system 103 receives an ACK from the communication controller 1205 of the modem-side system 103.

As illustrated by an arrow 1241, the main controller 1101 of the application-side system 105 resumes the USB device 155 of the application-side system 105 from the suspended state to the operational state. As illustrated by an arrow 1243, the main controller 1101 of the application-side system 105 receives an ACK from the USB device 155 of the application-side system 105.

As illustrated by an arrow 1245, the main controller 1101 of the application-side system 105 resumes the communication controller 1203 of the application-side system 105 from the suspended state to the operational state. The communication controller 1203 of the application-side system 105 instructs the USB device 155 to start communication, and the communication controller 1203 of the application-side system 105 receives an ACK from the USB device 155 of the application-side system 105. Then, as illustrated by an arrow 1247, the main controller 1101 of the application-side system 105 receives an ACK from the communication controller 1203 of the application-side system 105. At this timing, the connection between the USB device 135 of the modem-side system 103 and the USB device 155 of the application-side system 105 is established, in other words, the state shifts to a connection state 1249.

Then, as illustrated by an arrow 1251, the main controller 1201 of the modem-side system 103 receives notification of connection completion from the USB device 135 of the modem-side system 103 through the communication controller 1205 of the modem-side system 103.

Similarly, as illustrated by an arrow 1253, the main controller 1101 of the application-side system 105 receives notification of connection completion from the USB device 155 of the application-side system 105 through the communication controller 1203 of the application-side system 105.

When the connection has been established, the main controller 1101 of the application-side system 105 sends notification 1255 representing the communication is possible to the main controller 1201 of the modem-side system 103 through the USB connection path.

When receiving the notification 1255 representing that the communication is possible, the main controller 1201 of the modem-side system 103 sends incoming call event notification 1257 to the main controller 1101 of the application-side system 105 through the USB connection path.

The main controller 1101 of the application-side system 105 performs examination (or determination) 1259 of the event. Here, it is determined that the event is the incoming call event, the main controller 1101 of the application-side system 105 performs a processing 1261 for the call application.

In the processing 1261 for the call application, the main controller 1101 of the application-side system 105 communicates call data 1265 with a process 1263 for call in modem in the main controller 1201 through the USB connection path. The call data 1265 is data concerning call such as phone number of an opposite party or the like. The processing 1261 for the call application and the processing 1263 for call in modem are similar to those in the conventional art.

By using FIG. 12C, a next sequence to the sequence when the incoming call event occurs in this embodiment will be explained. When the main controller 1101 of the application-side system 105 ends the processing 1261 for the call application, the main controller 1101 sends disconnection notification 1271 to the main controller 1201 of the modem-side system 103 through the USB connection path. When the main controller 1201 of the modem-side system 103 receives the disconnection notification 1271, the main controller 1201 sends a response 1273 to the main controller 1101 of the application-side system 105 through the USB connection path. After this, the main controller 1201 of the modem-side system 103 and the main controller 1101 of the application-side system 105 execute a disconnection processing.

As illustrated by an arrow 1275, the main controller 1201 of the modem-side system 103 switches the signal level of the third signal line 655 to LOW through the second output terminal 615 of the modem-side system 103. Thus, it is represented that the CPU 131 of the modem-side system 103 is in the suspended state.

As illustrated by an arrow 1277, the main controller 1101 of the application-side system 105 switches the signal level of the fourth signal line 657 to LOW through the second output terminal 637 of the application-side system 105. Thus, it is represented that the CPU 151 of the application-side system 105 is in the suspended state.

As illustrated by an arrow 1279, the main controller 1201 of the modem-side system 103 stops the communication controller 1205 of the modem-side system 103. Furthermore, as illustrated by an arrow 1281, the main controller 1201 of the modem-side system 103 stops the USB device 135 of the modem-side system 103.

Moreover, as illustrated by an arrow 1283, the main controller 1101 of the application-side system 105 stops the communication controller 1203 of the application-side system 105. Furthermore, as illustrated by an arrow 1285, the main controller 1101 of the application-side system 105 stops the USB device 155 of the application-side system 105. Then, the connection between the USB device 135 of the modem-side system 103 and the USB device 155 of the application-side system 105 becomes a disconnection state 1287.

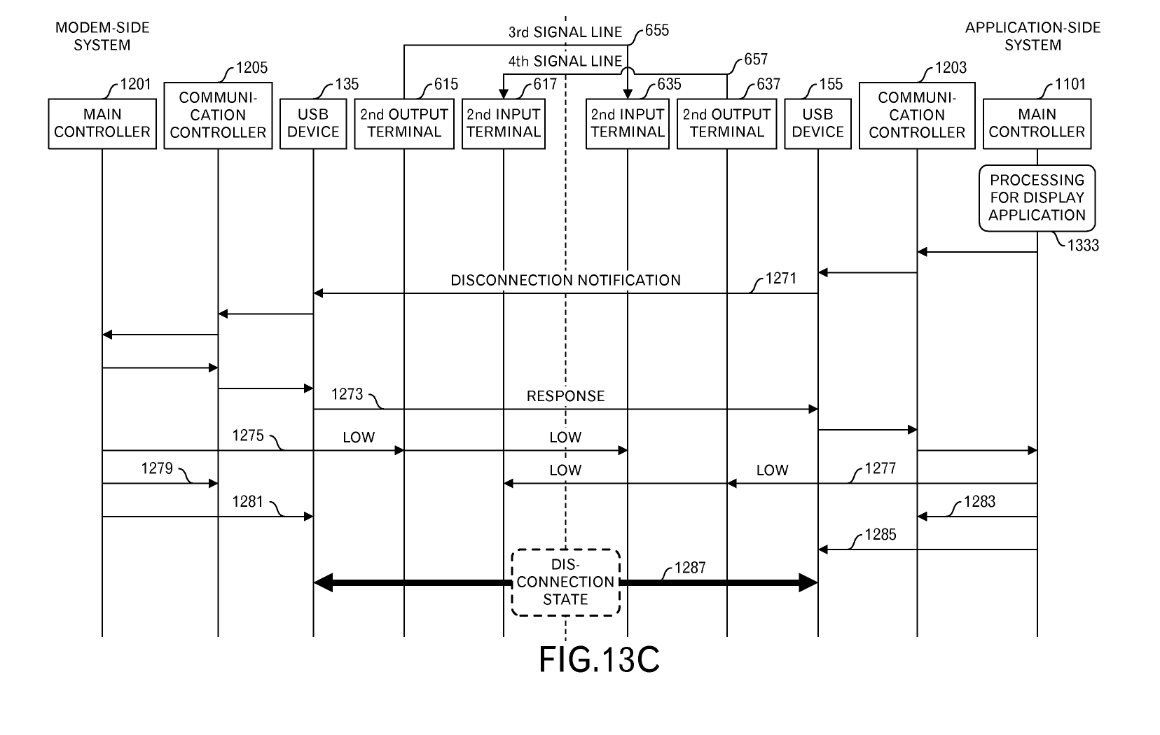

Next, a sequence when the RSSI event occurs in the first embodiment will be explained by using FIG. 13A. It is assumed that the state of the CPU 151 of the application-side system 105 is the operational state 1301. The state of the CPU 131 of the modem-side system 103 is the operational state. When the RSSI event 1303 occurs, the main controller 1201 of the modem-side system 103 obtains the signal level of the fourth signal line 657 through the second input terminal 617 of the modem-side system 103 as illustrated by an arrow 1305. Thus, HIGH is set to the signal level of the fourth signal line 657 by the main controller 1101 of the application-side system 105. Thus, it is represented that the state of the CPU 151 of the application-side system 105 is the operational state.

The main controller 1201 of the modem-side system 103 performs an examination (or determination) 1307 of an event that occurred and the state of the CPU 151 in the application-side system 105. Here, the RSSI event occurred, and the state of the CPU 151 in the application-side system 105 is the operational state. Therefore, it is determined that notification of the examination result is required. Hereinafter, a sequence when the RSSI event occurred and the state of the CPU 151 in the application-side system 105 is the operational state will be explained.

As illustrated by an arrow 1309, the main controller 1201 of the modem-side system 103 switches the signal level of the first signal line 651 to HIGH through the first output terminal 611 of the modem-side system 103. This is an interrupt signal for resuming the CPU 151 of the application-side system 105. However, because the CPU 151 of the application-side system 105 is the operational state, switching to HIGH has no substantial meaning. This is a processing to surely perform an operation.

As illustrated by an arrow 1311, the main controller 1101 of the application-side system 105 detects that the signal level of the first signal line 651 is HIGH through the first input terminal 631 of the application-side system 105. However, the CPU 151 of the application-side system 105 is in the operational state, so no particular processing is performed.

As illustrated by an arrow 1313, the main controller 1101 of the application-side system 105 switches the signal level of the fourth signal line 657 to HIGH through the second output terminal 637 of the application-side system 105. Accordingly, it is represented that the CPU 151 of the application-side system 105 is in the operating state.

As illustrated by an arrow 1315, the main controller 1101 of the application-side system 105 switches the signal level of the second signal line 653 to HIGH through the first output terminal 633 of the application-side system 105. This is an interrupt signal for resuming the CPU 131 of the modem-side system 103. However, because the CPU 131 of the modem-side system 103 is in the operational state, the switching the signal level has no substantial meaning. This is a processing to surely perform an operation.

As illustrated by an arrow 1317, the main controller 1201 of the modem-side system 103 detects that the signal level of the second signal line 653 is HIGH through the first input terminal 613 of the modem-side system 103. The CPU 131 of the modem-side system 103 is in the operational state, so the detection has no substantial meaning.

As illustrated by an arrow 1319, the main controller 1201 of the modem-side system 103 switches the signal level of the first signal line 651 to LOW through the first output terminal 611 of the modem-side system 103. Thus, an interrupt signal outputted at the arrow 1309 is terminated.

As illustrated by an arrow 1321, the main controller 1201 of the modem-side system 103 switches the signal level of the third signal line 655 to HIGH through the second output terminal 615 of the modem-side system 103. Thus, it is represented that the CPU 131 of the modem-side system 103 is operating.

As illustrated by an arrow 1323, when the main controller 1101 of the application-side system 105 detects that the signal level of the third signal line 655 is HIGH though the second input terminal 635, the main controller 1101 switches the signal level of the second signal line 653 to LOW through the first output terminal 633 as illustrated by an arrow 1325. Accordingly, an interrupt signal outputted by the arrow 1315 is terminated.

A next sequence to the sequence when the RSSI event occurs in this embodiment will be explained by using FIG. 13B. A flow from the arrow 1231 to the notification 1255 representing the communication is possible is similar to FIG. 12B. However, in such a case, the main controller 1201 of the modem-side system 103 outputs RSSI event notification 1331 to the main controller 1101 of the application-side system 105. In the examination (or determination) 1259, it is determined that the notified event is the RSSI event, and instead of the processing 1261 for the call application, which was illustrated in FIG. 12B, a processing 1333 for the display application is performed. In the processing 1333 for the display application, only display of the receiver sensitivity is performed based on the strength of the signal, which is included in the RSSI event data. So no transmission of the call data is performed.

FIG. 13C illustrates a next sequence to the sequence when the RSSI event occurs in the first embodiment. Instead of the processing 1261 for the call application, which was illustrated in FIG. 12C, a sequence similar to FIG. 12C is performed after the processing 1333 for the display application.

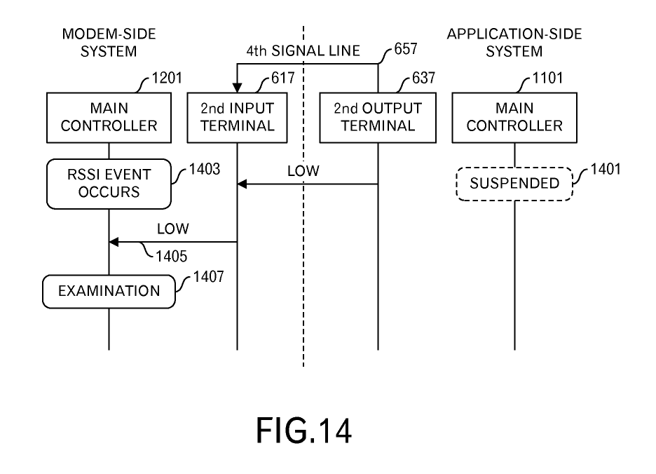

Next, a sequence when the RSSI event occurs in the suspended state of the CPU 151 in the application-side system 105 will be explained by using FIG. 14. It is assumed that the state of the CPU 151 of the application-side system 105 is the suspended state 1401. The state of the CPU 131 of the modem-side system 103 is the operational state.

When the RSSI event 1403 occurs, the main controller 1201 of the modem-side system 103 obtains the signal level of the fourth signal line 657 through the second input terminal 617 of the modem-side system 103 as illustrated by an arrow 1405. At this time, LOW is set to the signal level of the fourth signal line 657 by the main controller 1101 of the application-side system 105. This represents the state of the CPU 151 of the application-side system 105 is the suspended state.

The main controller 1201 of the modem-side system 103 performs an examination 1407 of the event that occurred and the state of the CPU 151 in the application-side system 105. Here, the RSSI event occurred, and the state of the CPU 151 of the application-side system 105 is the suspended state. Therefore, notification of the examination result (or determinations result) is not required. In such a case, without resuming the CPU 151 of the application-side system 105 from the suspended state to the operational state, the processing ends.

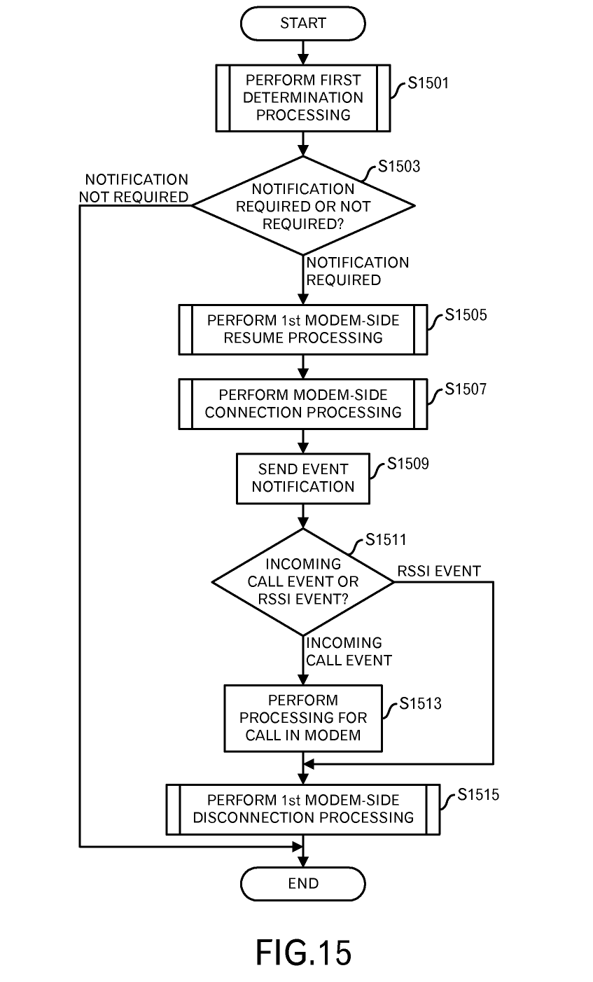

Next, a processing of the main controller 1201 of the modem-side system 103 in this embodiment will be explained by using FIG. 15. The main controller 1201 of the modem-side system 103 performs a first determination processing (S1501). The first determination processing corresponds to the examination 1209 illustrated in FIG. 12A, examination 1307 illustrated in FIG. 13A and examination 1407 illustrated in FIG. 14.

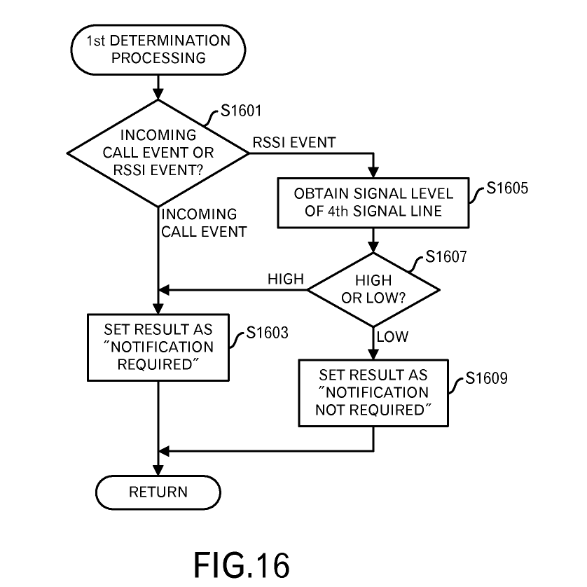

FIG. 16 illustrates a flow of the first determination processing. The main controller 1201 of the modem-side system 103 determines whether a type of the event that occurred is the incoming call event or the RSSI event (S1601). When it is determined that the type of the event that occurred is the incoming call event, the main controller 1201 of the modem-side system 103 sets a determination result (i.e. examination result) as “notification required” (S1603).

On the other hand, when it is determined that the type of the event that occurred is the RSSI event, the main controller 1201 of the modem-side system 103 obtains a signal level of the fourth signal line 657 through the second input terminal 617 of the modem-side system 103 (S1605). This corresponds to the arrow 1305 illustrated in FIG. 13A and the arrow 1405 illustrated in FIG. 14. The main controller 1201 of the modem-side system 103 determines whether the signal level of the fourth signal line 657 is HIGH or LOW (S1607). When it is determined that the signal level of the fourth signal line 657 is HIGH, the main controller 1201 sets a determination result (e.g. examination result) as “notification required” (S1603). When it is determined that the signal level of the fourth signal line 657 is LOW, the main controller 1201 of the modem-side system 103 sets a determination result (e.g. examination result) as “notification not required” (S1609).

Returning to the processing in FIG. 15, the main controller 1201 of the modem-side system 103 branches off the processing depending on the determination result (S1503). When the determination result is “notification not required”, the processing ends. When the determination result is “notification required”, the main controller 1201 of the modem-side system 103 performs a first modem-side resume processing (S1505). This corresponds to a processing from the arrow 1211 to arrow 1225, which are illustrated in FIG. 12A, and processing from the arrow 1309 to arrow 1321, which are illustrated in FIG. 13A.

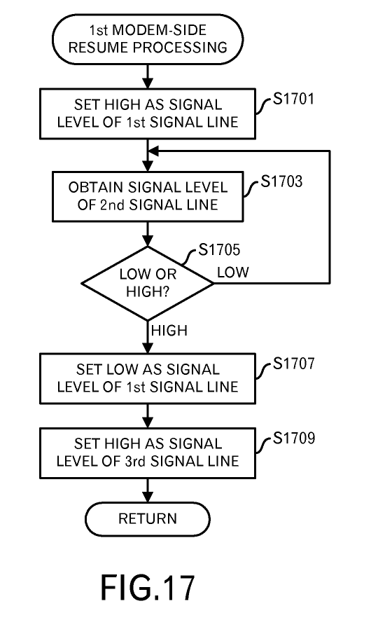

FIG. 17 illustrates a flow of the first modem-side resume processing. The main controller 1201 of the modem-side system 103 sets HIGH to the signal level of the first signal line 651 through the first output terminal 611 (S1701). This corresponds to the arrow 1211 illustrated in FIG. 12A, and the arrow 1309 illustrated in FIG. 13A.

The main controller 1201 of the modem-side system 103 obtains the signal level of the second signal line 653 through the first input terminal 613 (S1703). The main controller 1201 of the modem-side system 103 determines whether the signal level of the second signal line 653 is HIGH or LOW (S1705). When it is determined that the signal level of the second signal line 653 is LOW, the processing returns to S1703. This processing is repeated until it is determined that the signal level of the second signal line 653 is HIGH. This corresponds to the arrow 1221 illustrated in FIG. 12A, and the arrow 1317 illustrated in FIG. 13A.

The main controller 1201 of the modem-side system 103 sets LOW to the signal level of the first signal line 651 (S1707). This corresponds to the arrow 1223 illustrated in FIG. 12A, and the arrow 1319 illustrated in FIG. 13A.

The main controller 1201 of the modem-side system 103 sets HIGH to the signal level of the third signal line 655 (S1709). This corresponds to the arrow 1225 illustrated in FIG. 12A, and the arrow 1321 illustrated in FIG. 13A.

Returning to the processing in FIG. 15, the main controller 1201 of the modem-side system 103 performs a modem-side connection processing (S1507). This corresponds to a processing from the arrow 1231 to arrow 1255, which are illustrated in FIG. 12B and FIG. 13B.

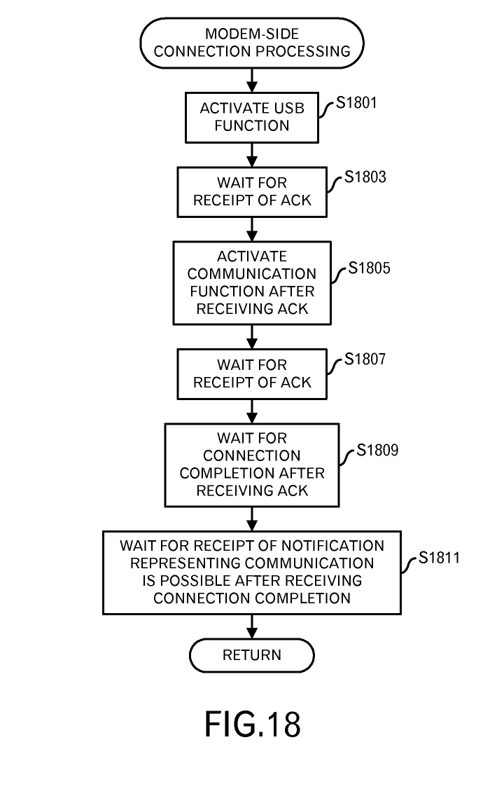

FIG. 18 illustrates a flow of the modem-side connection processing. The main controller 1201 of the modem-side system 103 activates a USB function by the USB device 135 in the modem-side system 103 (S1801). By this step, the state of the USB device 135 of the modem-side system 103 shifts to the operational state. This corresponds to the arrow 1231 illustrated in FIG. 12B and FIG. 13B.

The main controller 1201 of the modem-side system 103 waits for receipt of an ACK from the USB device 135 of the modem-side system 103 (S1803). This corresponds to the arrow 1233 illustrated in FIG. 12B and FIG. 13B.

After receiving the ACK, the main controller 1201 of the modem-side system 103 activates a communication function by the communication controller 1205 of the modem-side system 103 (S1805). Thus, the state of the communication controller 1205 of the modem-side system 103 becomes the operational state. This corresponds to the arrow 1235 illustrated in FIG. 12B and FIG. 13B.

The main controller 1201 of the modem-side system 103 waits for receipt of an ACK from the communication controller 1205 of the modem-side system 103 (S1807). This corresponds to the arrow 1237 illustrated in FIG. 12B and FIG. 13B.

After receiving the ACK, the main controller 1201 of the modem-side system 103 waits for notification of the connection completion from the communication controller 1205 of the modem-side system 103 (S1809). This corresponds to the arrow 1251 illustrated in FIG. 12B and FIG. 13B.

After receiving the notification, the main controller 1201 of the modem-side system 103 waits for receipt of notification representing that the communication is possible from the main controller 1101 of the application-side system 105 (S1811). This corresponds to the arrow 1255 illustrated in FIG. 12B and FIG. 13B. After receiving the notification, the processing returns to the calling-source processing.

Returning to the processing in FIG. 15, the main controller 1201 of the modem-side system 103 transmits event notification (S1509). This corresponds to the arrow 1257 illustrated in FIG. 12B, and the arrow 1331 illustrated in FIG. 13B.

The main controller 1201 of the modem-side system 103 determines whether a type of the notified event is the incoming call event or RSSI event (S1511). When it is determined that the type of the notified event is the incoming call event, the main controller 1201 of the modem-side system 103 performs a processing for call in modem (S1513).

This corresponds to the processing 1263 for call in modem, which is illustrated in FIG. 12B. When the processing for the call application by the main controller 1101 of the application-side system 105 ends, the main controller 1201 of the modem-side system 103 ends the processing for call in modem (S1513), and performs a first modem-side disconnection processing (S1515). Also when it is determined that the type of the notified event is the RSSI event, the processing shifts to the first modem-side disconnection processing. The first modem-side disconnection processing corresponds to a processing from the arrow 1271 to arrow 1281, which are illustrated in FIG. 12C and FIG. 13C.

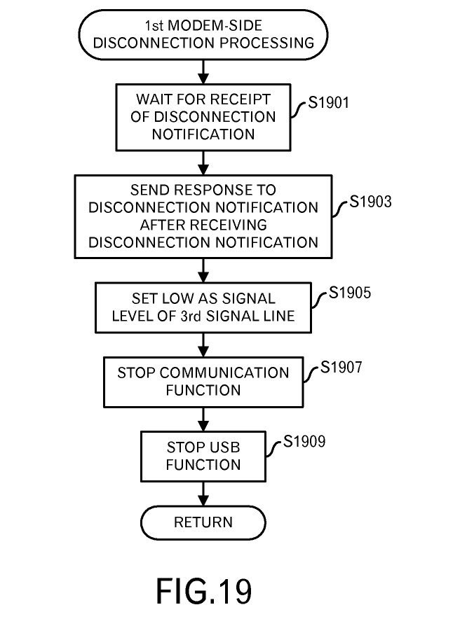

FIG. 19 illustrates a flow of the first modem-side disconnection processing. The main controller 1201 of the modem-side system 103 waits for receipt of disconnection notification from the main controller 1101 of the application-side system 105 through the USB connection path (S1901). This corresponds to the arrow 1271 illustrated in FIG. 12C and FIG. 13C.

After receiving the disconnection notification, the main controller 1201 of the modem-side system 103 transmits a response to the disconnection notification to the main controller 1101 of the application-side system 105 through the USB connection path (S1903). This corresponds to the arrow 1273 illustrated in FIG. 12C and FIG. 13C.

The main controller 1201 of the modem-side system 103 sets LOW as the signal level of the third signal line 655 through the second output terminal 615 of the modem-side system 103 (S1905). This corresponds to the arrow 1275 illustrated in FIG. 12C and FIG. 13C.

The main controller 1201 of the modem-side system 103 stops the communication function by the communication controller 1205 of the modem-side system 103 (S1907). This corresponds to the arrow 1279 illustrated in FIG. 12C and FIG. 13C.

The main controller 1201 of the modem-side system 103 stops the USB function by the USB device 135 of the modem-side system 103 (S1909). This corresponds to the arrow 1281 illustrated in FIG. 12C and FIG. 13C.

When the first modem-side disconnection processing ends, the processing in FIG. 15 ends.

Next, a processing in the application-side system 105 will be explained. The state of the CPU 151 of the application-side system 105 shifts from the suspended state to the operational state, when it is detected through the first input terminal 631 of the application-side system 105 that the signal level of the first signal line 651 is HIGH, as illustrated in FIG. 12A. In the following, a processing after this shift by the main controller 1101 of the application-side system 105 will be explained.

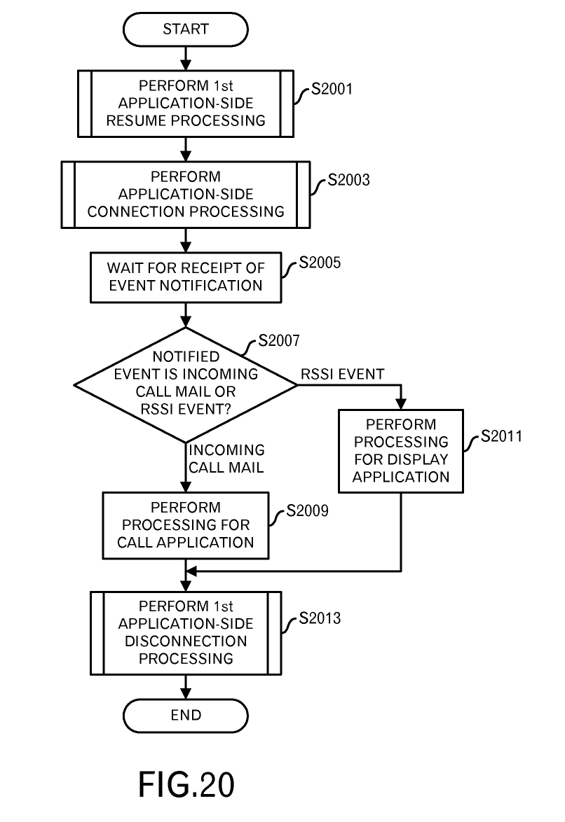

A processing by the main controller 1101 of the application-side system 105 in this embodiment will be explained by using FIG. 20. The main controller 1101 of the application-side system 105 performs a first application-side resume processing (S2001). This corresponds to the processing from the arrow 1213 to arrow 1229, which are illustrated in FIG. 12A, and the processing from the arrow 1311 to arrow 1325, which are illustrated in FIG. 13A.

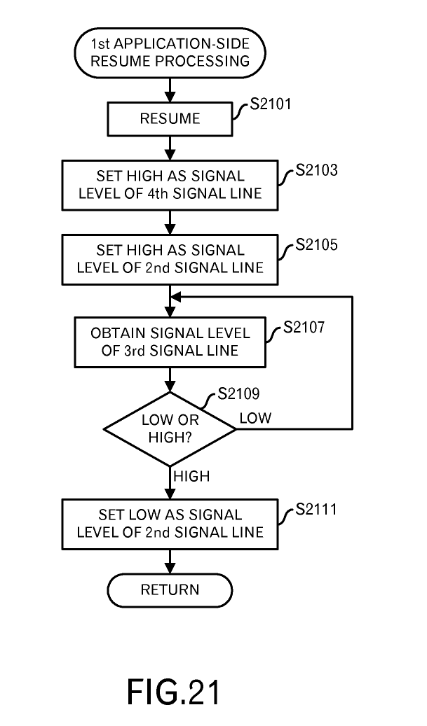

FIG. 21 illustrates a flow of the first application-side resume processing. The CPU 151 of the application-side system 105 shifts its own state from the suspended state to the operational state in response to an interrupt signal (S2101). Specifically, when the CPU 151 of the application-side system 105 detects that the signal level of the first signal line 651 is HIGH through the first input terminal 631 of the application-side system 105, the CPU 151 of the application-side system 105 determines that the interrupt signal for the resume was received. However, when the CPU 151 of the application-side system 105 has already been operating, no particular processing is conducted.

The main controller 1101 of the application-side system 105 sets HIGH as the signal level of the fourth signal line 657 through the second output terminal 637 (S2103). This corresponds to the arrow 1217 illustrated in FIG. 12A and the arrow 1313 illustrated in FIG. 13A.

The main controller 1101 of the application-side system 105 sets HIGH as the signal level of the second signal line 653 through the first output terminal 633 (S2105). This corresponds to the arrow 1219 illustrated in FIG. 12A and the arrow 1315 illustrated in FIG. 13A.

The main controller 1101 of the application-side system 105 obtains the signal level of the third signal line 655 through the second input terminal 635 (S2107). This corresponds to the arrow 1227 illustrated in FIG. 12A, and the arrow 1323 illustrated in FIG. 13A.

The main controller 1101 of the application-side system 105 determines whether the signal level of the third signal line 655 is HIGH or LOW (S2109). When it is determined that the signal level of the third signal line 655 is LOW, the processing returns to S2107. This processing is repeated until it is determined that the signal level of the third signal line 655 is HIGH. This corresponds to the arrow 1227 illustrated in FIG. 12A and the arrow 1323 illustrated in FIG. 13A.

The main controller 1101 of the application-side system 105 sets LOW as the signal level of the second signal line 653 through the first output terminal 633 (S2111). This corresponds to the arrow 1229 illustrated in FIG. 12A and the arrow 1325 illustrated in FIG. 13A.

Returning to the processing in FIG. 20, the main controller 1101 of the application-side system 105 performs an application-side connection processing (S2003). This corresponds to the processing from the arrow 1241 to arrow 1255, which are illustrated in FIG. 12B and FIG. 13B.

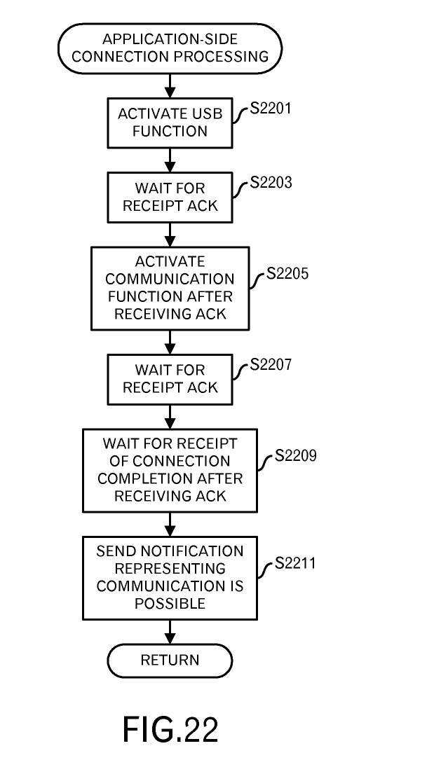

FIG. 22 illustrates a flow of the application-side connection processing. The main controller 1101 of the application-side system 105 activates the USB function by the USB device 155 of the application-side system 105 (S2201). By this step, the USB device 155 of the application-side system 105 becomes operating. This corresponds to the arrow 1241 illustrated in FIG. 12B and FIG. 13B.

The main controller 1101 of the application-side system 105 waits for receipt of the ACK from the USB device 155 of the application-side system 105 (S2203). This corresponds to the arrow 1243 illustrated in FIG. 12B and FIG. 13B.

After receiving the ACK, the main controller 1101 of the application-side system 105 activates the communication function by the communication controller 1203 of the application-side system 105 (S2205). By this step, the communication controller 1203 of the application-side system 105 becomes operating. This corresponds to the arrow 1245 illustrated in FIG. 12B and FIG. 13B.

The main controller 1101 of the application-side system 105 waits for the receipt of the ACK from the communication controller 1203 of the application-side system 105 (S2207). This corresponds to the arrow 1247 illustrated in FIG. 12B and FIG. 13B.

After receiving the ACK, the main controller 1101 of the application-side system 105 waits for notification of the connection completion from the communication controller 1203 of the application-side system 105 (S2209). This corresponds to the arrow 1253 illustrated in FIG. 12B and FIG. 13B.

After receiving the notification, the main controller 1101 of the application-side system 105 transmits the notification representing that the communication is possible to the main controller 1201 of the modem-side system 103 (S2211). This corresponds to the arrow 1255 illustrated in FIG. 12B and FIG. 13B. After receiving the notification, the processing returns to the calling-source processing.

Returning to the processing in FIG. 20, the main controller 1101 of the application-side system 105 waits for receipt of event notification (S2005). This corresponds to the arrow 1257 illustrated in FIG. 12B and arrow 1331 illustrated in FIG. 13B.

After receiving the event notification, the main controller 1101 of the application-side system 105 determines whether a type of the notified event is the incoming call event or RSSI event (S2007). When it is determined that the type of the notified event is the incoming event, the main controller 1101 of the application-side system 105 performs the processing for the call application (S2009). This corresponds to the processing for the call application 1261, which is illustrated in FIG. 12B.

When it is determined that the type of the notified event is the RSSI event, the main controller 1101 of the application-side system 105 performs the processing for the display application (S2011). This corresponds to the processing 1333 for the display application, which is illustrated in FIG. 13B.

The main controller 1101 of the application-side system 105 performs the first application-side disconnection processing (S2013). This corresponds to the processing from the arrow 1271 to arrow 1285, which are illustrated in FIG. 12C and FIG. 13C.

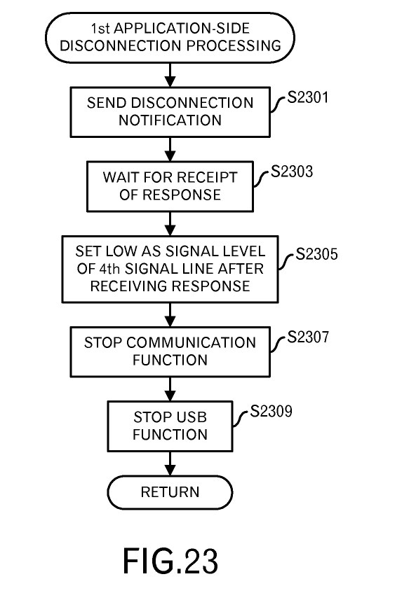

FIG. 23 illustrates a flow of the first application-side disconnection processing. The main controller 1101 of the application-side system 105 transmits disconnection notification to the main controller 1201 of the modem-side system 103 through the USB connection path (S2301). This corresponds to the arrow 1271 illustrated in FIG. 12C and FIG. 13C.

The main controller 1101 of the application-side system 105 waits for receipt of a response from the main controller 1201 of the modem-side system 103 through the USB connection path (S2303). This corresponds to the arrow 1273 illustrated in FIG. 12C and FIG. 13C.

After receiving the response, the main controller 1101 of the application-side system 105 sets LOW to the signal level of the fourth signal line 657 through the second output terminal 637 of the application-side system 105 (S2305). This corresponds to the arrow 1277 illustrated in FIG. 12C and FIG. 13C.

The main controller 1101 of the application-side system 105 stops the communication function by the communication controller 1203 of the application-side system 105 (S2307). This corresponds to the arrow 1283 illustrated in FIG. 12C and FIG. 13C.

The main controller 1101 of the application-side system 105 stops the USB function by the USB device 155 of the application-side system 105 (S2309). This corresponds to the arrow 1285 illustrated in FIG. 12C and FIG. 13C.

When the first application-side disconnection processing ends, the processing in FIG. 20 ends.

In the aforementioned comparative example, as illustrated in FIG. 2, when the application-side CPU resumes by itself, the modem-side CPU is resumed once. Moreover, when the application-side CPU stops by itself, the modem-side CPU is resumed once. Therefore, every time when the resume or stop of the application-side CPU occurs, the modem-side CPU is resumed to be operating, so the power is consumed in the aforementioned comparative example.

On the other hand, in this embodiment, as illustrated in FIG. 7, when the application-side CPU 151 resumes by itself, the modem-side CPU 131 is not resumed. Moreover, even when the application-side CPU 151 stops by itself, the modem-side CPU 131 is not resumed. Therefore, even when the resume or stop of the application-side CPU 151 occurs, the power required for the resume and operation of the modem-side CPU 131 is not consumed.

Thus, because the state of the application-side CPU 151 is informed to the modem-side CPU 131 through the fourth signal line 657, the number of times of the resume of the modem-side CPU 131 is reduced, and the consumed power is suppressed.

Moreover, when the application-side CPU 151 is operating, the notification of the RSSI event is made, and when the application-side CPU 151 is suspended, the application-side CPU 151 is not resumed to the operational state, and the notification of the RSSI event is omitted, Therefore, it is possible to suppress the power consumption according to the state of the application-side CPU 151.

Moreover, when the application-side CPU 151 is suspended and the incoming call event occurs in the modem-side system 103, the application-side CPU 151 is resumed and the notification of the incoming call event is made. Therefore, it is possible to suspend the application-side CPU 151 in a situation that there is a possibility of receiving the incoming call, and it is also possible to suppress the power consumption of the application-side CPU 151 in the waiting state.

### Embodiment 2

In this embodiment, an example will be explained in which its own CPU state is informed to the other CPU by using a signal line for outputting the interrupt signal for resuming the other CPU from the suspended state to the operational state together.

The hardware configuration of the communication apparatus 101 in this embodiment is similar to that in FIG. 1. The first signal line 191 is used to output an interrupt signal for resuming the CPU 151 of the application-side system 105 from the CPU 131 of the modem-side system 103, and also used to inform the state of the CPU 131 of the modem-side system 103. Furthermore, the second signal line 193 is used to output an interrupt signal for resuming the CPU 131 of the modem-side system 103 from the CPU 151 of the application-side system 105 and is also used to inform the state of the CPU 151 of the application-side system 105.

However, as for either of the first signal line 191 and second signal line 193, the detection of the interrupt signal is performed by a trigger-method. In other words, an interrupt occurs at a timing when the signal level shifts from LOW to HIGH.

Moreover, as for either of the first signal line 191 and second signal line 193, the signal level being HIGH represents that the state of the CPU is the operational state, and the signal level being LOW represents the state of the CPU is the suspended state.

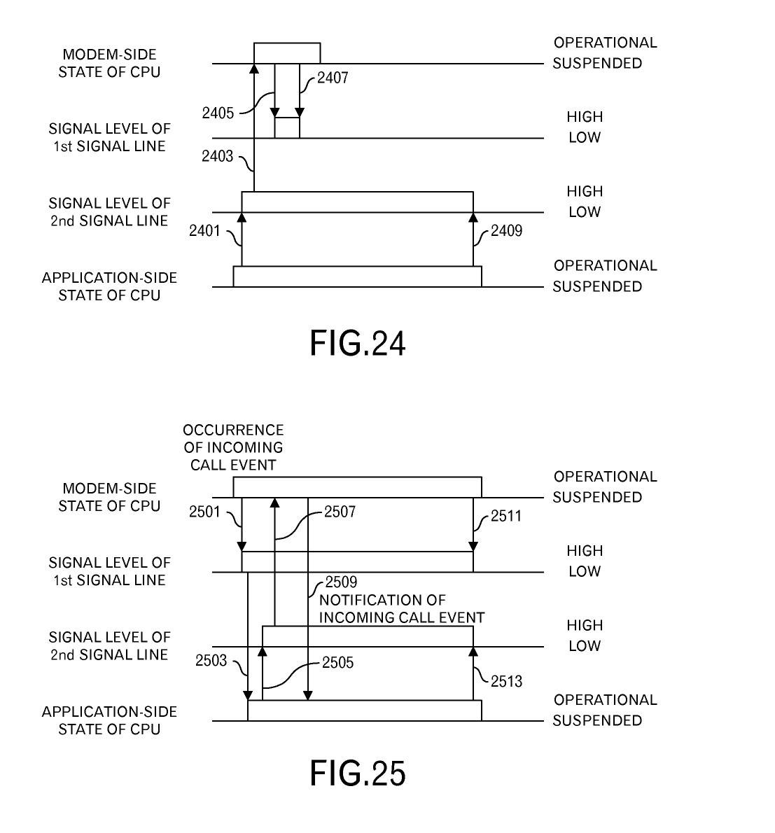

FIG. 24 illustrates a state transition at the resume and stop of the CPU 151 in the application-side system 105 in the second embodiment. When shifting from the suspended state to the operational state because the CPU 151 of the application-side system 105 is resumed, the CPU 151 of the application-side system 105 switches the signal level of the second signal line 193 from LOW to HIGH as illustrated by an arrow 2401.

When the CPU 131 of the modem-side system 103 detects that the signal level of the second signal line 193 is HIGH, the CPU 131 resumes by itself as illustrated by an arrow 2403. Thus, the CPU 131 of the modem-side system 103 shifts from the suspended state to the operational state.

Then, as illustrated by an arrow 2405, the CPU 131 of the modem-side system 103 switches the signal level of the first signal line 191 to HIGH in order to represent its own CPU 131 is operating. After that, when no processing is carried out, the CPU 131 of the modem-side system 103 returns the signal level of the first signal line 191 to LOW as illustrated by an arrow 2407.

On the other hand, when the state of the CPU 151 of the application-side system 105 shifts from the operational state to the suspended state because the CPU 151 stops, the CPU 151 of the application-side system 105 switches the signal level of the second signal line 193 from HIGH to LOW as illustrated by an arrow 2409.

Similarly to the first embodiment, when the incoming call is received, an application program is executed even when the CPU 151 of the application-side system 105 is operating or suspended. Therefore, the CPU 131 of the modem-side system 103 resumes the CPU 151 of the application-side system 105, which is in the suspended state, to the operational state. In a state that the CPU 151 of the application-side system 105 is operating, when the interrupt signal for the resume is received from the CPU 131 of the modem-side system 103, no particular processing is carried out because the CPU 151 has already been resumed.

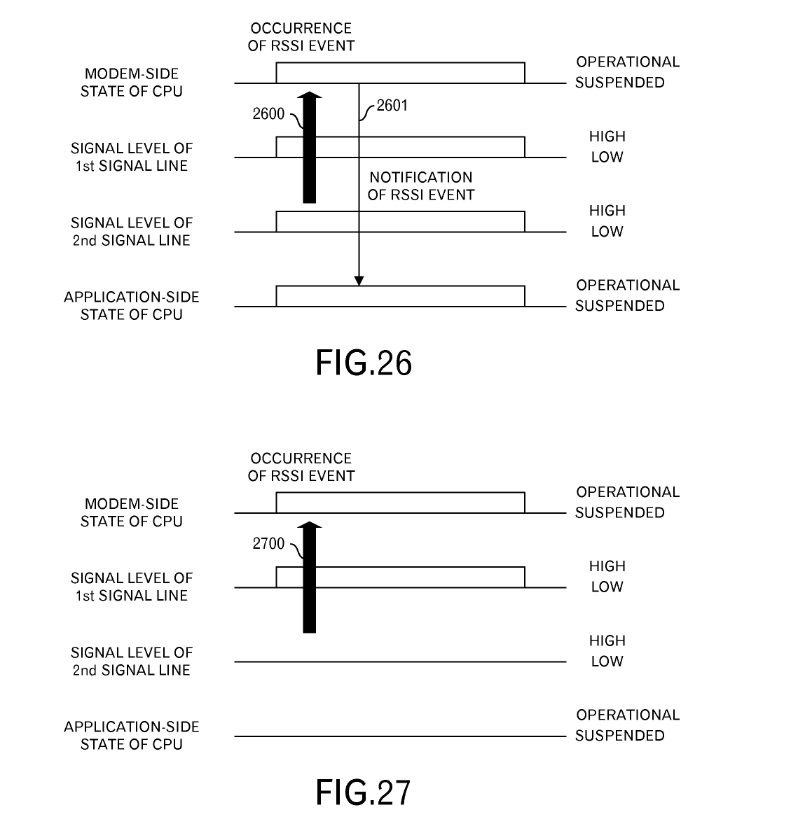

FIG. 25 illustrates a state transition when the incoming call event occurs in the second embodiment. The incoming call event occurs when a connection request is received by the wireless device 141. When an incoming call event occurs in the CPU 131 of the modem-side system 103, the CPU 131 of the modem-side system 103 switches the signal level of the first signal line 191 from LOW to HIGH as illustrated by an arrow 2501.

When the CPU 151 of the application-side system 105 detects that the signal level of the first signal line 191 is HIGH, the CPU 151 resumes by itself as illustrated by an arrow 2503. Then, as illustrated by an arrow 2505, the CPU 151 of the application-side system 105 switches the signal level of the second signal line 193 from LOW to HIGH.

As illustrated by an arrow 2507, the CPU 131 of the modem-side system 103 detects that the signal level of the second signal line 193 is HIGH. However, the CPU 131 has already been resumed, so no particular processing is conducted.

As illustrated by an arrow 2509, the CPU 131 of the modem-side system 103 transmits notification of the incoming call event to the CPU 151 of the application-side system 105 through the USB connection path. Then, the CPU 151 of the application-side system 105 performs a processing for the application program according to the incoming call event.

When the call ends and the CPU 131 of the modem-side system 103 suspends, the CPU 131 switches the signal level of the first signal line 191 from HIGH to LOW as illustrated by an arrow 2511. Moreover, when the CPU 151 of the application-side system 105 suspends, the CPU 151 switches the signal level of the second signal line 193 from HIGH to LOW as illustrated by an arrow 2513.

Next, a state transition when the RSSI event occurs in this embodiment will be explained. Similarly to the aforementioned embodiment and also in this embodiment, only when the CPU 151 of the application-side system 105 is operating, display of the receiver sensitivity is carried out. When the CPU 151 of the application-side system 105 is suspended, the display of the receiver sensitivity is not carried out.

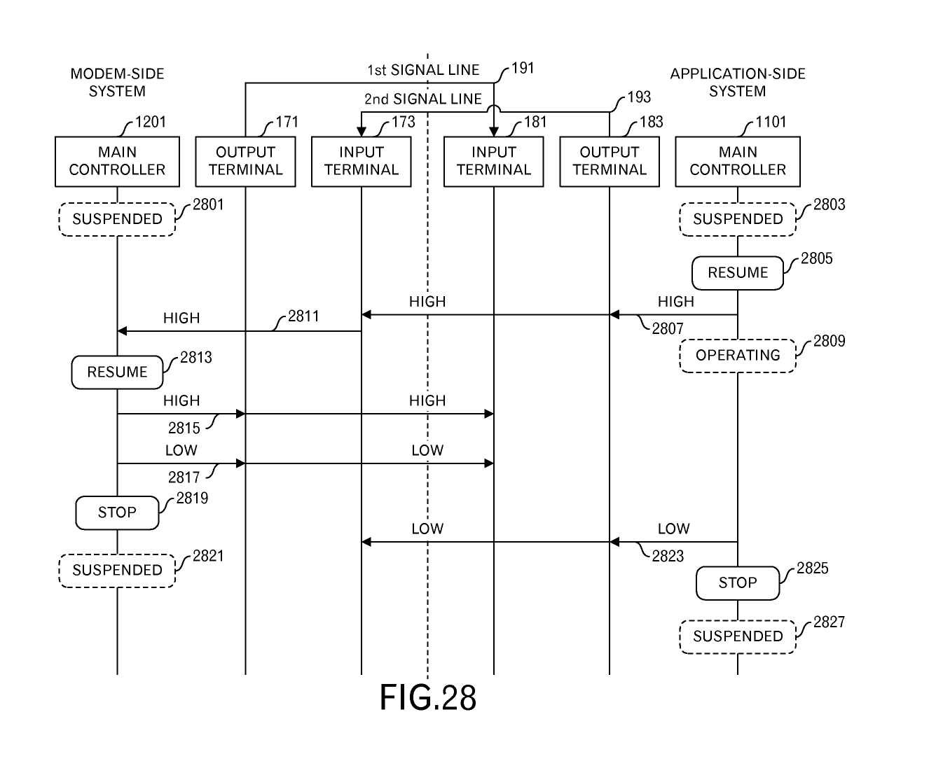

A state transition when the RSSI event occurs while the CPU 151 of the application-side system 105 is operating will be explained by using FIG. 26. The CPU 131 of the modem-side system 103 determines that the CPU 151 of the application-side system 105 is operating, because the signal level of the second signal line 193 is HIGH, as illustrated by an arrow 2600.

Then, as illustrated by an arrow 2601, the CPU 131 of the modem-side system 103 transmits notification of the RSSI event to the CPU 151 of the application-side system 105 through the USB connection path. After that, the CPU 151 of the application-side system 105 perform a processing for an application program according to the RSSI event.

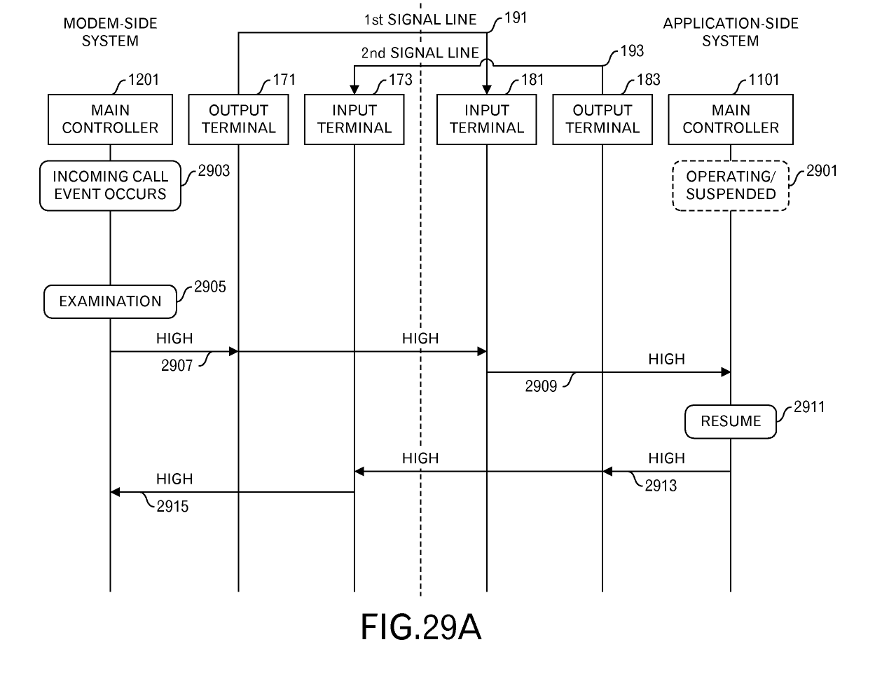

Next, a state transition when the RSSI event occurs while the CPU 151 of the application-side system 105 is suspended will be explained by using FIG. 27. When the RSSI event occurs, the CPU 131 of the modem-side system 103 determines that the CPU 151 of the application-side system 105 is suspended, because the signal level of the second signal line 193 is LOW as illustrated by an arrow 2700. In such a case, notification of the RSSI event is not performed.

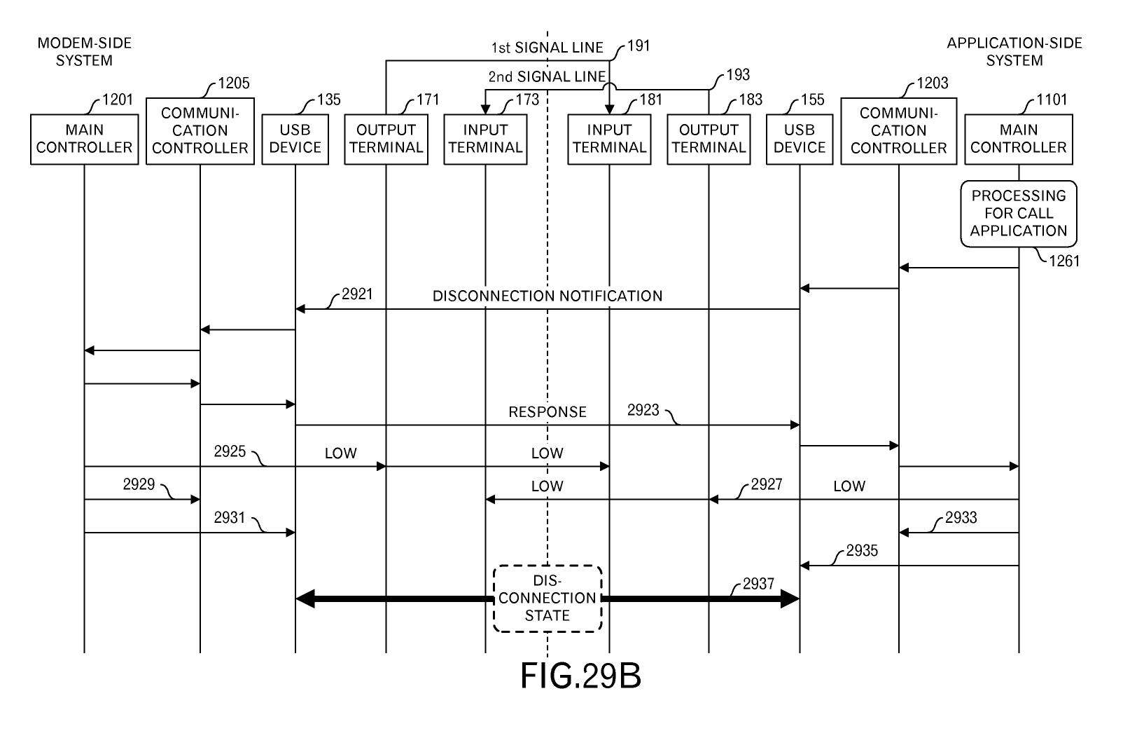

In the following, sequences in this embodiment will be explained. First, a sequence at the resume and stop of the CPU 151 in the application-side system 105 in this embodiment will be explained by using FIG. 28.

It is assumed that the state of the CPU 131 of the modem-side system 103 is being suspended (2801), and the state of the CPU 151 of the application-side system 105 is being suspended (2803). When, in response to an input of the interrupt signal or the like, the CPU 151 of the application-side system 105 is resumed (2805), the main controller 1101 of the application-side system 105 switches the signal level of the second signal line 193 to HIGH through the output terminal 183 of the application-side system 105 as illustrated by an arrow 2807. Thus, the state of the CPU 151 of the application-side system 105 shifts to the operational state (2809).

On the other hand, as illustrated by an arrow 2811, when the main controller 1201 of the modem-side system 103 detects that the signal level of the second signal line 193 is HIGH through the input terminal 173 of the modem-side system 103, the CPU 131 of the modem-side system 103 is resumed (2813). However, when the CPU 131 has already been operating, no particular processing is carried out.

As illustrated by an arrow 2815, the main controller 1201 of the modem-side system 103 switches the signal level of the first signal line 191 through the output terminal 171 of the modem-side system 103. After that, when no processing is carried out, the main controller 1201 of the modem-side system 103 returns the signal level of the first signal line 191 to LOW through the output terminal 171 of the modem-side system 103, as illustrated by an arrow 2817.

Then, the main controller 1201 of the modem-side system 103 stops the CPU 131 (2819). By this step, the state of the CPU 131 of the modem-side system 103 becomes the suspended state 2821.

When the main controller 1101 of the application-side system 105 stops by itself, the main controller 1101 switches the signal level of the second signal line 193 to LOW through the output terminal 183 of the application-side system 105.

Then, when the main controller 1101 of the application-side system 105 stops the CPU 151 (2825), the state of the CPU 151 of the application-side system 105 shifts to the suspended state 2827.

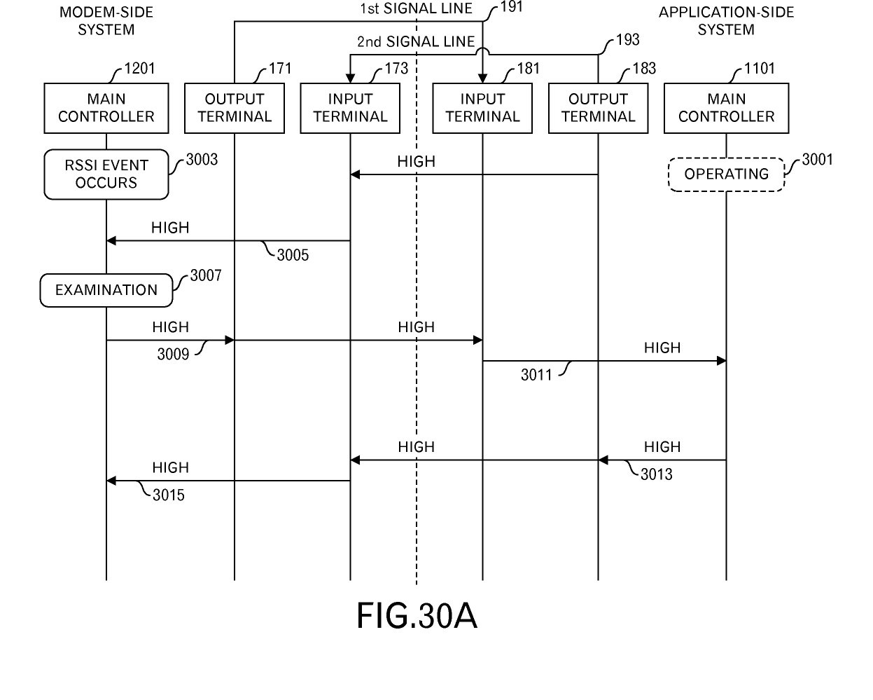

Next, a sequence when the incoming call event occurs in this embodiment will be explained by using FIG. 29A.

It is assumed that the state of the CPU 151 of the application-side system 105 is the operational state or suspended state 2901. The sequence is the same even in case of the operational state and even in case of the suspended state. The state of the CPU 131 of the modem-side system 103 is the operational state. The main controller 1201 of the modem-side system 103 examines an event that occurred (2905), when the incoming call event occurred (2903). Because the incoming call event occurred, “notification required” is set as the examination result (which corresponds to determination result). In the following, a sequence when the event that occurred is the incoming call event will be explained.

As illustrated by an arrow 2907, the main controller 1201 of the modem-side system 103 switches the signal level of the first signal line 191 from LOW to HIGH through the output terminal 171 of the modem-side system 103. This is an interrupt signal for resuming the CPU 151 of the application-side system 105.

Then, as illustrated by an arrow 2909, when it is detected that the signal level of the first signal line 191 is switched from LOW to HIGH through the input terminal 181 of the application-side system 105, the CPU 151 of the application-side system 105 is resumed (2911). However, when the CPU 151 has already been resumed, no particular processing is performed.

As illustrated by an arrow 2913, the main controller 1101 of the application-side system 105 switches the signal level of the second signal line 193 from LOW to HIGH through the output terminal 183 of the application-side system 105. With this step, it is represented by the CPU 151 of the application-side system 105 is operating.

As illustrated by an arrow 2915, the main controller 1201 of the modem-side system 103 detects that the signal level of the second signal line 193 shifts from LOW to HIGH through the input terminal 173 of the modem-side system 103. This switch of the signal level corresponds to an interrupt for resuming the CPU 151 of the application-side system 105 from the suspended state to the operational state. However, the CPU 151 of the application-side system 105 has already been operating, so no particular processing is carried out.

The subsequent processing of FIG. 29A is the same as the sequence illustrated in FIG. 12B. By using FIG. 29B, a next sequence to the sequence illustrated in FIG. 12B will be explained.

When the processing 1261 for the call application ends, the main controller 1101 of the application-side system 105 transmits disconnection notification 2921 to the main controller 1201 of the modem-side system 103 through the USB connection path.

When the main controller 1201 of the modem-side system 103 receives the disconnection notification 2921, the main controller 1201 transmits a response 2923 to the main controller 1101 of the application-side system 105 through the USB connection path. After this, the main controller 1201 of the modem-side system 103 and the main controller 1101 of the application-side system 105 shift to a disconnection processing.

As illustrated by an arrow 2925, the main controller 1201 of the modem-side system 103 switches the signal level of the first signal line 191 to LOW through the output terminal 171 of the modem-side system 103. With this step, it is represented that the CPU 131 of the modem-side system 103 is suspended.

As illustrated by an arrow 2927, the main controller 1101 of the application-side system 105 switches the signal level of the second signal line 193 to LOW through the output terminal 183 of the application-side system 105. With this step, it is represented that the CPU 151 of the application-side system 105 is suspended.

As illustrated by an arrow 2929, the main controller 1201 of the modem-side system 103 stops the communication controller 1205 of the modem-side system 103. Furthermore, as illustrated by an arrow 2931, the main controller 1201 of the modem-side system 103 stops the USB device 135 of the modem-side system 103.

As illustrated by an arrow 2933, the main controller 1101 of the application-side system 105 stops the communication controller 1203 of the application-side system 105. Furthermore, as illustrated by an arrow 2935, the main controller 1101 of the application-side system 105 stops the USB device 155 of the application-side system 105. Then, the connection between the USB device 135 of the modem-side system 103 and the USB device 155 of the application-side system 105 is disconnected (2937).

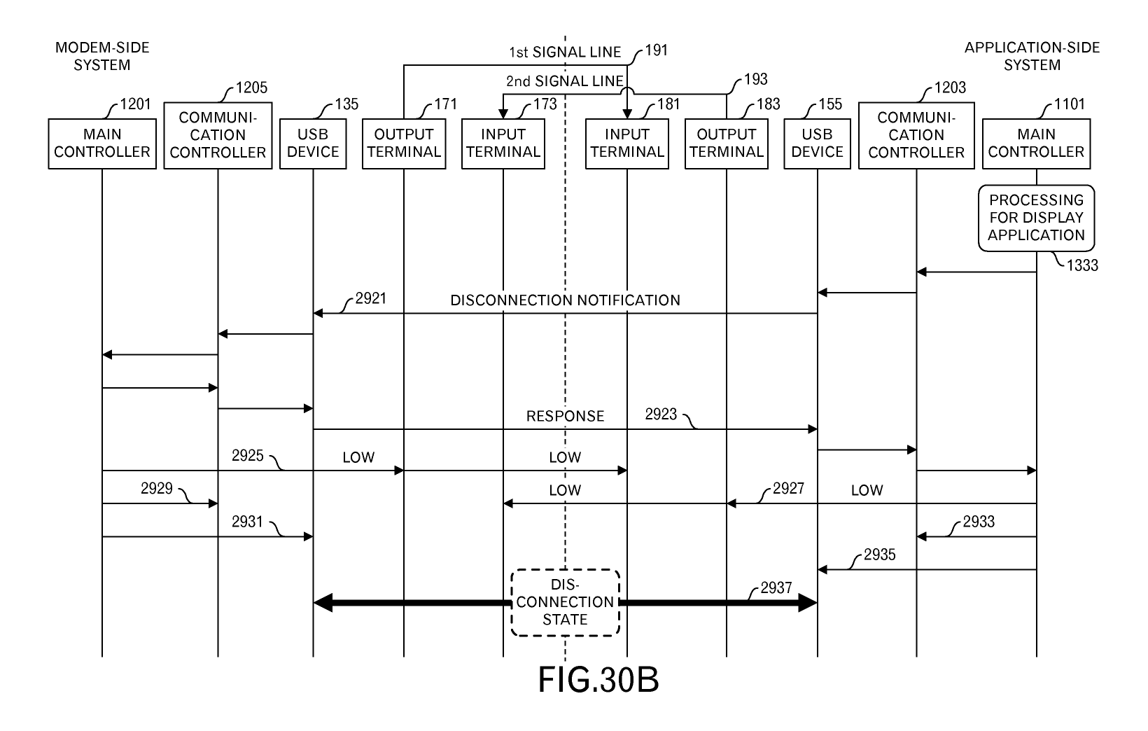

Next, a sequence when the RSSI event occurs in this embodiment will be explained by using FIG. 30A.

It is assumed that the state of the CPU 151 of the application-side system 105 is the operational state 3001. The state of the CPU 131 of the modem-side system 103 is the operational state. When the RSSI event 3003 occurs, the main controller 1201 of the modem-side system 103 obtains the signal level of the second signal line 193 through the input terminal 173 of the modem-side system 103 as illustrated by an arrow 3005. At this time, as the signal level of the second signal line 193, HIGH is set by the main controller 1101 of the application-side system 105. This represents that the state of the CPU 151 of the application-side system 105 is the operational state.

The main controller 1201 of the modem-side system 103 examines the event that occurred and the state of the CPU 151 of the application-side system 105 (3007). Here, because the RSSI event occurred and the state of the CPU 151 of the application-side system 105 is the operational state, “notification required” is set as the examination result (which corresponds to the determination result). In the following, a sequence when the RSSI event occurred and the state of the CPU 151 of the application-side system 105 is the operational state will be explained.

As illustrated by an arrow 3009, the main controller 1201 of the modem-side system 103 switches the signal level of the first signal line 191 to HIGH through the output terminal 171 of the modem-side system 103. This is a signal representing the state of the CPU 131 of the modem-side system 103, and also an interrupt for resuming the CPU 151 of the application-side system 105 from the suspended state to the operational state. However, the CPU 151 of the application-side system 105 is operating, so the signal does not function as the interrupt.

As illustrated by an arrow 3011, the main controller 1101 of the application-side system 105 detects that the signal level of the first signal line 191 is HIGH through the input terminal 181 of the application-side system 105. However, the CPU 151 of the application-side system 105 is operating, so no particular processing is carried out.

As illustrated by an arrow 3013, the main controller 1101 of the application-side system 105 switches the signal level of the second signal line 193 to HIGH through the output terminal 183 of the application-side system 105. This is a signal representing the state of the CPU 151 of the application-side system 105, and also an interrupt for resuming the CPU 131 of the modem-side system 103. However, the CPU 131 of the modem-side system 103 is operating, so the signal does not function as the interrupt.

As illustrated by an arrow 3015, the main controller 1201 of the modem-side system 103 detects that the signal level of the second signal line 193 is HIGH through the input terminal 173 of the modem-side system 103. However, the CPU 131 of the modem-side system 103 is operating, so no particular processing is carried out.

A subsequence sequence of FIG. 30A is similar to the sequence illustrated in FIG. 13B. By using FIG. 30B, a next sequence to the sequence illustrated in FIG. 13B will be explained. Instead of the processing 1261 for the call application, which is illustrated in FIG. 29B, after the processing 1333 for the display application, the similar sequence to FIG. 29B is carried out.

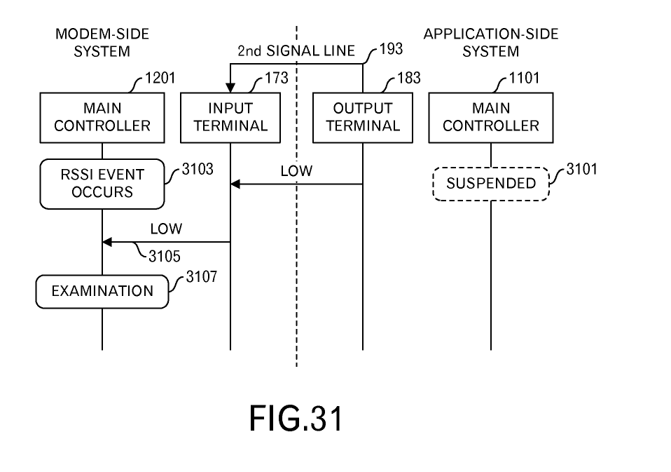

Next, a sequence when the CPU 151 of the application-side system 105 is suspended and the RSSI event occurred will be explained by using FIG. 31. It is assumed that the state of the CPU 151 of the application-side system 105 is the suspended state 3101. The state of the CPU 131 of the modem-side system 103 is the operational state.

When the RSSI event 3103 occurred, the main controller 1201 of the modem-side system 103 obtains the signal level of the second signal line 193 through the input terminal 173 of the modem-side system 103 as illustrated by an arrow 3105. At this time, LOW is set as the signal level of the second signal line 193 by the main controller 1101 of the application-side system 105. This represents that the state of the CPU 151 of the application-side system 105 is suspended.

The main controller 1201 of the modem-side system 103 examines the event that occurred and the state of the CPU 151 of the application-side system 105 (3107). Here, because the RSSI event occurred and the state of the CPU 151 of the application-side system 105 is the suspended state, “notification not required” is set as the examination result (which corresponds to the determination result). In such a case, without resuming the CPU 151 of the application-side system 105 from the suspended state to the operational state, the processing ends.

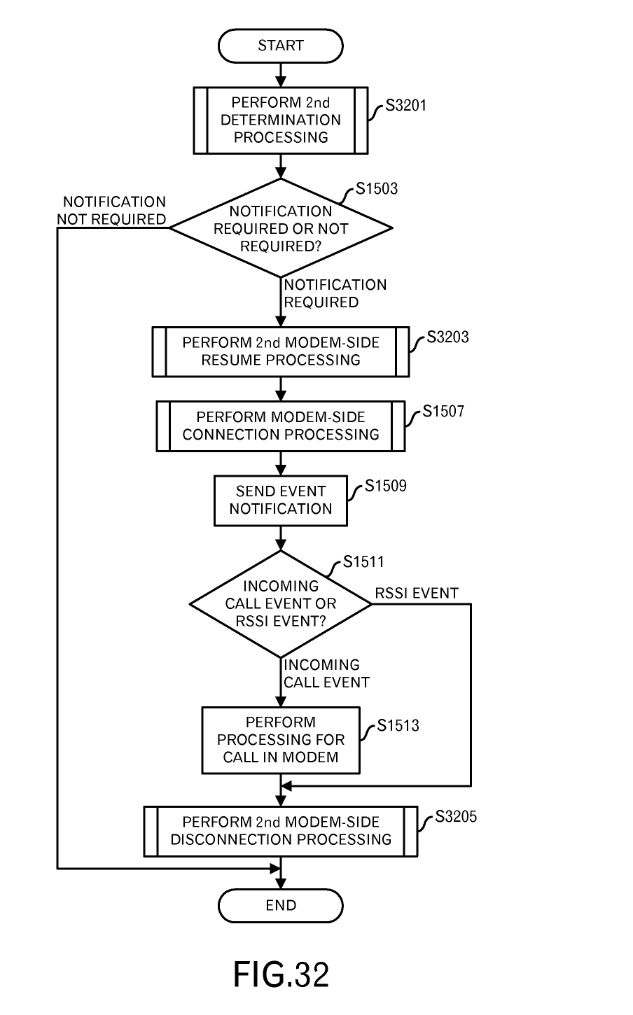

Next, a processing by the main controller 1201 of the modem-side system 103 in this embodiment will be explained by using FIG. 32. The main controller 1201 of the modem-side system 103 performs a second determination processing instead of the aforementioned first determination processing (S3201). The second determination processing corresponds to the examination 2905 illustrated in FIG. 29A, examination 3007 illustrated in FIG. 30A and examination 3107 illustrated in FIG. 31.

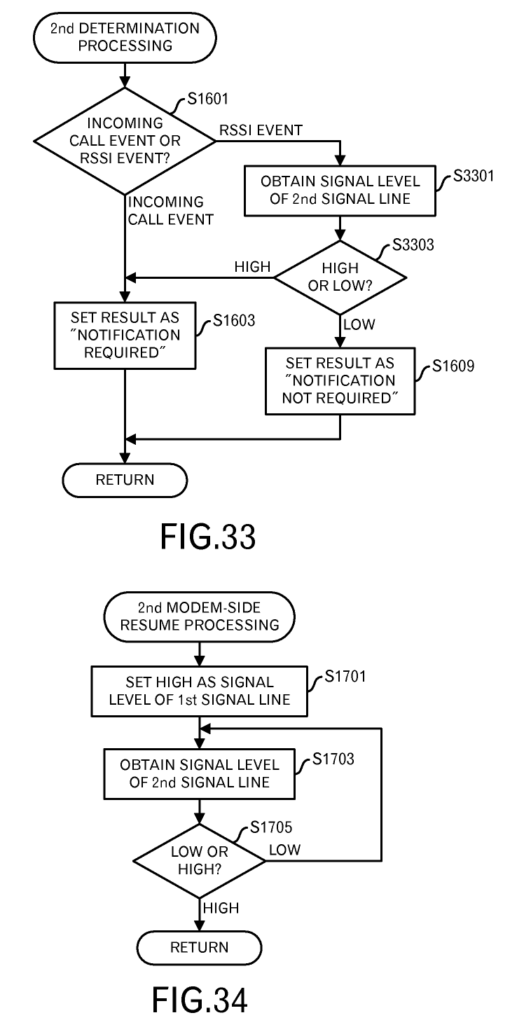

FIG. 33 illustrates a flow of the second determination processing. The main controller 1201 of the modem-side system 103 determines whether a type of the event that occurred is the incoming call event or RSSI event (S1601). When it is determined that the type of the event that occurred is the incoming call event, the main controller 1201 of the modem-side system 103 sets “notification required” as the determination result (i.e. examination result) (S1603).

On the other hand, when it is determined that the type of the event that occurred is the RSSI event, the main controller 1201 of the modem-side system 103 obtains the signal level of the second signal line 193 through the input terminal 173 of the modem-side system 103 (S3301). This corresponds to the arrow 3005 illustrated in FIG. 30A, and the arrow 3105 illustrated in FIG. 31.

The main controller 1201 of the modem-side system 103 determines whether the signal level of the second signal line 193 is HIGH or LOW (S3303). When it is determined that the signal level of the second signal line 193 is HIGH, the main controller 1201 sets “notification required” as the determination result (i.e. examination result) (S1603). When it is determined that the signal level of the second signal line 193 is LOW, the main controller 1201 of the modem-side system 103 sets “notification not required” as the determination result (S1609).

Returning to the processing in FIG. 32, the main controller 1201 of the modem-side system 103 branches off the processing depending on the determination result (S1503). When the determination result is “notification not required”, the processing ends. When the determination result is “notification required”, the main controller 1201 of the modem-side system 103 performs a second modem-side resume processing instead of the aforementioned first modem-side resume processing (S3203).

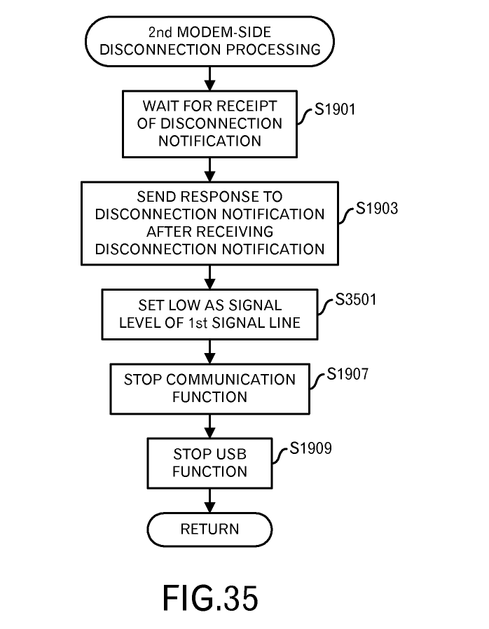

FIG. 34 illustrates a flow of the second modem-side resume processing. The main controller 1201 of the modem-side system 103 sets HIGH as the signal level of the first signal line 191 through the output terminal 171. This corresponds to the arrow 2907 illustrated in FIG. 29A and the arrow 3009 illustrated in FIG. 30A.

The main controller 1201 of the modem-side system 103 obtains the signal level of the second signal line 193 through the input terminal 173 (S1703). The main controller 1201 of the modem-side system 103 determines whether the signal level of the second signal line 193 is HIGH or LOW (S1705). When it is determined that the signal level of the second signal line 193 is LOW, the processing returns to S1703. This processing is repeated until it is determined that the signal level of the second signal line 193 is HIGH. This corresponds to the arrow 2915 illustrated in FIG. 29A, and the arrow 3015 illustrated in FIG. 30A.

Returning to the processing in FIG. 32, the main controller 1201 of the modem-side system 103 performs the modem-side connection processing (S1507). The modem-side connection processing (S1507) is the same as that explained using FIG. 18.

The main controller 1201 of the modem-side system 103 transmits event notification (S1509). This corresponds to the arrow 1257 illustrated in FIG. 12B, and the arrow 1331 illustrated in FIG. 13B.

The main controller 1201 of the modem-side system 103 determines whether a type of the notified event is the incoming call event or RSSI event (S1511). When it is determined that the type of the notified event is the incoming call event, the main controller 1201 of the modem-side system 103 performs the processing for call in modem (S1513). This corresponds to the processing 1263 for call in modem, which is illustrated in FIG. 12B.

When the processing for the call application by the main controller 1101 of the application-side system 105 ends, the main controller 1201 of the modem-side system 103 ends the processing for call in modem (S1513), and performs a second modem-side disconnection processing instead of the aforementioned first modem-side disconnection processing (S3205).

When it is determined at S1511 that the type of the notified event is the RSSI event, the processing shifts to the second modem-side disconnection processing. The second modem-side disconnection processing corresponds to the processing from the arrow 2921 to arrow 2937, which are illustrated in FIG. 29B and FIG. 30B.

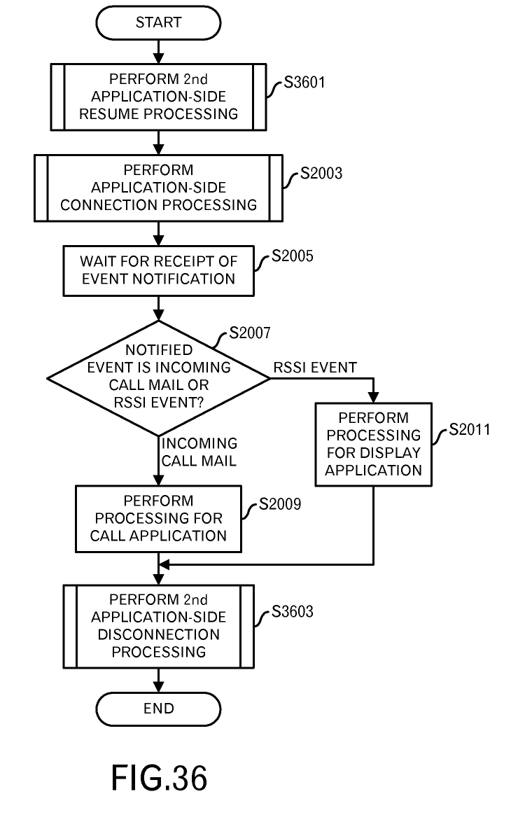

FIG. 35 illustrates a flow of the second modem-side disconnection processing. The main controller 1201 of the modem-side system 103 waits for receipt of the disconnection notification from the main controller 1101 of the application-side system 105 through the USB connection path (S1901). This corresponds to the arrow 2921 illustrated in FIG. 29B and FIG. 30B.

After receiving the disconnection notification, the main controller 1201 of the modem-side system 103 transmits a response to the disconnection notification to the main controller 1101 of the application-side system 105 through the USB connection path (S1903). This corresponds to the arrow 2923 illustrated in FIG. 29B and FIG. 30B.

The main controller 1201 of the modem-side system 103 sets LOW as the signal level of the first signal line 191 through the output terminal 171 of the modem-side system 103 (S3501). This corresponds to the arrow 2925 illustrated in FIG. 29B and FIG. 30B.

The main controller 1201 of the modem-side system 103 stops the communication function by the communication controller 1205 of the modem-side system 103 (S1907). This corresponds to the arrow 2929 illustrated in FIG. 29B and FIG. 30B.

The main controller 1201 of the modem-side system 103 stops the USB function by the USB device 135 of the modem-side system 103 (S1909). This corresponds to the arrow 2931 illustrated in FIG. 29B and FIG. 30B.

When the second modem-side disconnection processing ends, the processing in FIG. 32 ends.

Next, the processing in the application-side system 105 will be explained. As illustrated in FIG. 29A, when the CPU 151 of the application-side system 105 detects that the signal level of the first signal line 191 is HIGH through the input terminal 181 of the application-side system 105, the CPU 151 resumes from the suspended state to the operational state. In the following, the processing by the main controller 1101 of the application-side system 105 after the resume will be explained.

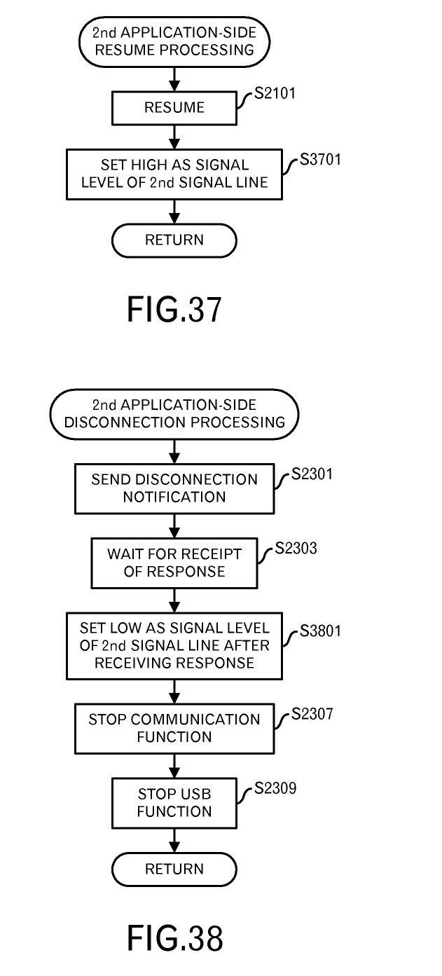

The processing by the main controller 1101 of the application-side system 105 in the second embodiment will be explained by using FIG. 36. The main controller 1101 of the application-side system 105 performs a second application-side resume processing instead of the aforementioned first application-side resume processing (S3601). This corresponds to the processing from the arrow 2909 to arrow 2913, which are depicted in FIG. 29A, and the processing from the arrow 3011 to arrow 3013, which are depicted in FIG. 30A.

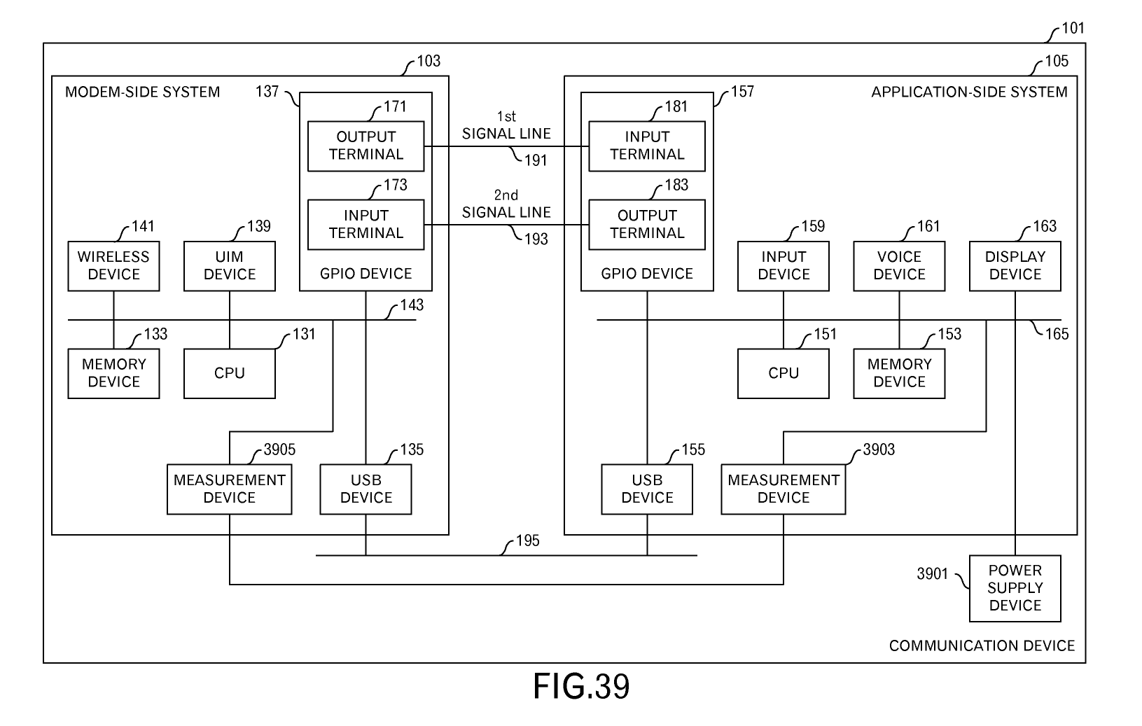

FIG. 37 illustrates a flow of the second application-side resume processing. The CPU 151 of the application-side system 105 resumes from the suspended state to the operational state in response to an interrupt signal (S2101). Specifically, when the CPU 151 of the application-side system 105 detects that the signal level of the first signal line 191 is switched from LOW to HIGH through the input terminal 181 of the application-side system 105, the CPU 151 determines that the interrupt regarding the resume was received. However, when the CPU 151 of the application-side system 105 has already been operating, no particular processing is performed.

The main controller 1101 of the application-side system 105 sets HIGH as the signal level of the second signal line 193 through the output terminal 183 of the application-side system 105 (S3701). This corresponds to the arrow 2913 illustrated in FIG. 29A, and the arrow 3013 illustrated in FIG. 30A.

Returning to the processing in FIG. 36, the main controller 1101 of the application-side system 105 performs the application-side connection processing (S2003). This corresponds to the processing from the arrow 1241 to arrow 1255, which are illustrated in FIG. 12B and FIG. 13B. The application-side connection processing is the same as that described above by using FIG. 22.

The main controller 1101 of the application-side system 105 waits for receipt of the event notification (S2005). This corresponds to the arrow 1257 illustrated in FIG. 12B and the arrow 1331 illustrated in FIG. 13B.

After receiving the event notification, the main controller 1101 of the application-side system 105 determines whether a type of the notified event is the incoming call event or RSSI event (S2007). When it is determined that the type of notified event is the incoming call event, the main controller 1101 of the application-side system 105 performs the processing for the call application (S2009). This corresponds to the processing for the call application 1261, which is illustrated in FIG. 12B.

When the type of the notified event is the RSSI event, the main controller 1101 of the application-side system 105 performs the processing for the display application (S2011). This corresponds to the processing for the display application 1333, which is illustrated in FIG. 13B.

When the processing for the call application or display application ends, the main controller 1101 of the application-side system 105 performs a second application-side disconnection processing instead of the aforementioned first application-side disconnection processing (S3603). This corresponds to the processing from the arrow 2921 to arrow 2935, which are illustrated in FIG. 29B and FIG. 30B.

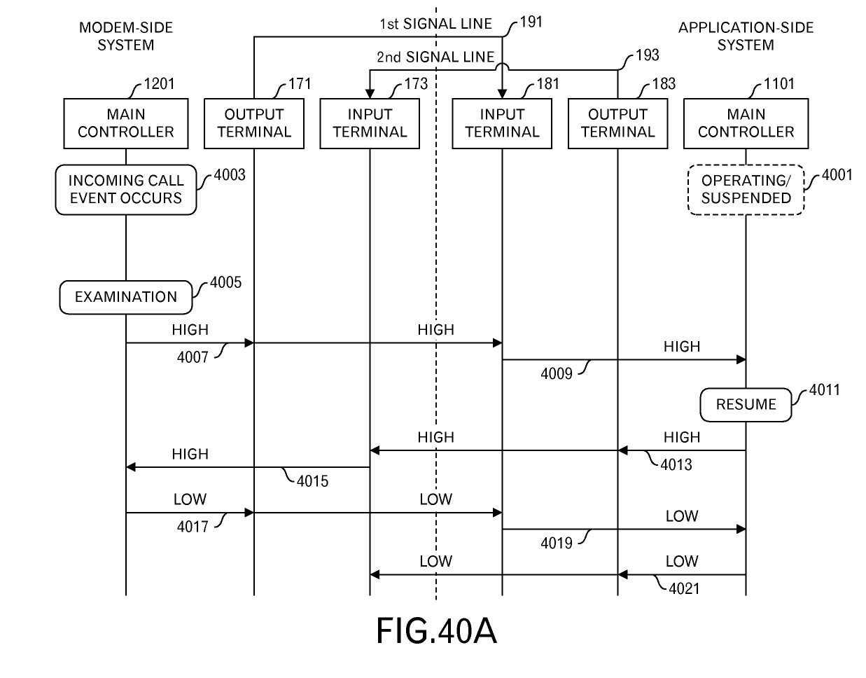

FIG. 38 illustrates a flow of the second application-side disconnection processing. The main controller 1101 of the application-side system 105 transmits disconnection notification to the main controller 1201 of the modem-side system 103 through the USB connection path (S2301). This corresponds to the arrow 2921 illustrated in FIG. 29B and FIG. 30B.

The main controller 1101 of the application-side system 105 waits for receipt of a response from the main controller 1201 of the modem-side system 103 through the USB connection path (S2303). This corresponds to the arrow 2923 illustrated in FIG. 29B and FIG. 30B.

The main controller 1101 of the application-side system 105 sets LOW as the signal level of the second signal line 193 through the output terminal 183 of the application-side system 105 (S3801). This corresponds to the arrow 2927 illustrated in FIG. 29B and FIG. 30B.

The main controller 1101 of the application-side system 105 stops the communication function by the communication controller 1203 of the application-side system 105 (S2307). This corresponds to the arrow 2933 illustrated in FIG. 29B and FIG. 30B.

The main controller 1101 of the application-side system 105 stops the USB function by the USB device 155 of the application-side system 105 (S2309). This corresponds to the arrow 2935 illustrated in FIG. 29B and FIG. 30B.

When the second application-side disconnection processing ends, the processing in FIG. 36 ends.

According to this embodiment, by using the second signal line 193 provided to deliver the interrupt signal for resuming the modem-side CPU 131 to the operational state by the application-side CPU 151, it is possible to inform the modem-side CPU 131 of the state of the application-side CPU 151. Therefore, the number of signal lines is reduced, and the configuration of the communication apparatus 101 is simplified.

### Embodiment 3

In the aforementioned embodiments, the state of the CPU is passed through the signal line. However, in this embodiment, an example will be explained in which the state of the CPU is determined by measuring a value of a current inputted to the CPU.

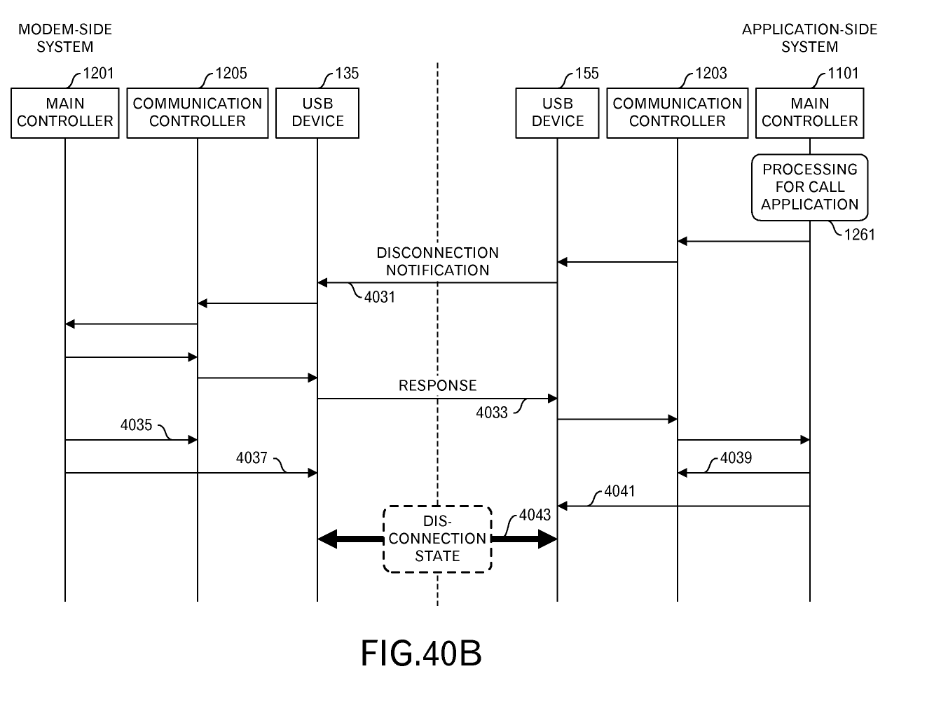

FIG. 39 illustrates a hardware configuration example of a communication apparatus 101 in this embodiment. Similarly to FIG. 1, the modem-side system 103 has the CPU 131, memory device 133, USB device 135, GPIO device 137, UIM device 139, wireless terminal 141 and bus 143. Similarly to FIG. 1, the application-side system 105 has the CPU 151, memory device 153, USB device 155, GPIO device 157, input device 159, voice device 161, display device 163 and bus 165.

In this embodiment, the application-side system 105 further has a power supply device 3901 and measurement device 3903. The power supply device 3901 supplies the power to the CPU 151. The measurement device 3903 measures a value of a current inputted to the CPU 151 from the power supply device 3901. Then, the measurement device 3903 determines, based on the measured current value, whether the CPU 151 of the application-side system 105 is operating or stopped. For example, when the measured current value exceeds a predetermined threshold, the measurement device 3903 determines that the CPU 151 is operating, and when the measured current value is equal to or less than the predetermined threshold, the measurement device 3903 determines that the CPU 151 is being stopped.

The modem-side system 103 further has a measurement device 3905. The measurement device 3905 of the modem-side system 103 and the measurement device 3903 of the application-side system 105 are connected via a signal line, bus or the like. The CPU 131 obtains a determination result representing whether the CPU 151 of the application-side system 105 is operating or stopping from the measurement device 3903 of the application-side system 105 through the measurement device 3905 of the modem-side system 103.

The first signal line 191 and second signal line 193 are used for sending the interrupt signal for the resume, similarly to the aforementioned comparative example.

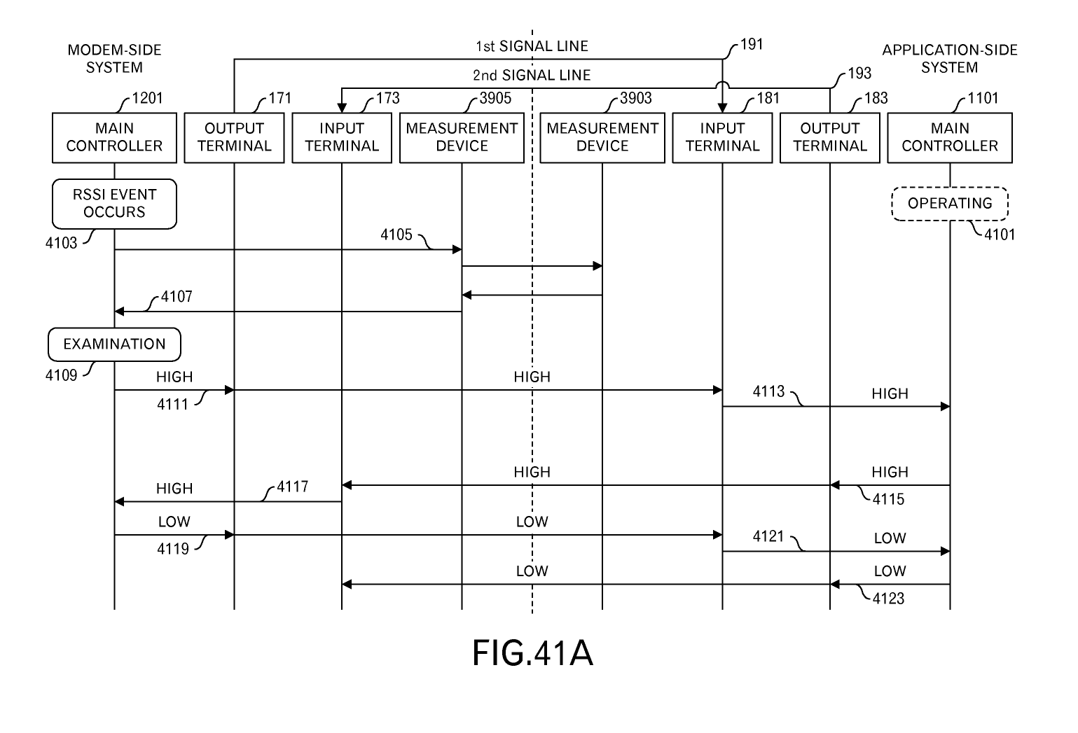

Next, a sequence when the incoming call event occurs in this embodiment will be explained using FIG. 40A. It is assumed that the state of the CPU 151 of the application-side system 105 is the operational state or suspended state 4001. Regardless of whether the state is the operational state or suspended state, the sequence is the same. The state of the CPU 131 of the modem-side system 103 is the operational state. The main controller 1201 of the modem-side system 103 examines the event 4005 that occurred, when the incoming call event 4003 occurred. Because the incoming call event occurred, “notification required” is set as the examination result. In the following, a sequence when the event that occurred is the incoming call event will be explained.

As illustrated by an arrow 4007, the main controller 1201 of the modem-side system 103 switches the signal level of the first signal line 191 from LOW to HIGH through the output terminal 171 of the modem-side system 103. This is an interrupt signal for resuming the CPU 151 of the application-side system 105.

Then, as illustrated by an arrow 4009, when the CPU 151 of the application-side system 105 detects that the signal level of the first signal line 191 is switched from LOW to HIGH through the input terminal 181 of the application-side system 105, the CPU 151 of the application-side system 105 is resumed (4011). However, when the CPU 151 of the application-side system 105 has already been resumed, no particular processing is performed.

As illustrated by an arrow 4013, the main controller 1101 of the application-side system 105 switches the signal level of the second signal line 193 from LOW to HIGH through the output terminal 183 of the application-side system 105. This is an interrupt signal for the resume to the CPU 131 of the modem-side system 103. However, the CPU 131 of the modem-side system 103 has already been operating, so this signal does not function substantially.

As illustrated by an arrow 4015, the main controller 1201 of the modem-side system 103 detects that the signal level of the second signal line 193 is HIGH through the input terminal 173 of the modem-side system 103. However, the CPU 131 of the modem-side system 103 has already been operating, so no particular processing is carried out.

As illustrated by an arrow 4017, the main controller 1201 of the modem-side system 103 switches the signal level of the first signal line 191 through the output terminal 171 of the modem-side system 103. Therefore, the interrupt signal outputted at the timing of the arrow 4007 is terminated.

When the main controller 1101 of the application-side system 105 detects that the signal level of the first signal line 191 is switched to LOW through the input terminal 181 of the application-side system 105 as illustrated by an arrow 4019, the main controller 1101 of the application-side system 105 switches the signal level of the second signal line 193 to LOW through the output terminal 183 of the application-side system 105 as illustrated by an arrow 4021. With this step, the interrupt signal outputted at the timing of the arrow 4013 is terminated.

A next sequence to the sequence illustrated in FIG. 40A is the same as the sequence illustrated in FIG. 12B. A next sequence to the sequence illustrated in FIG. 12B will be explained by using FIG. 40B.

When the main controller 1101 of the application-side system 105 ends the processing 1261 for the call application, the main controller 1101 sends disconnection notification 4031 to the main controller 1201 of the modem-side system 103 through the USB connection path.

When the main controller 1201 of the modem-side system 103 receives the disconnection notification 4031, the main controller 1201 sends a response 4033 to the main controller 1101 of the application-side system 105 through the USB connection path. After this step, the processing by the main controller 1201 of the modem-side system 103 and the main controller 1101 of the application-side system 105 shifts to a processing for the disconnection.

As illustrated by an arrow 4035, the main controller 1201 of the modem-side system 103 stops the communication controller 1205 of the modem-side system 103. Furthermore, as illustrated by an arrow 4037, the main controller 1201 of the modem-side system 103 stops the USB device 135 of the modem-side system 103.

As illustrated by an arrow 4039, the main controller 1101 of the application-side system 105 stops the communication controller 1203 of the application-side system 105. Furthermore, as illustrated by an arrow 4041, the main controller 1101 of the application-side system 105 stops the USB device 155 of the application-side system 105. Then, the connection between the USB device 135 of the modem-side system 103 and the USB device 155 of the application-side system 105 is disconnected (4043).

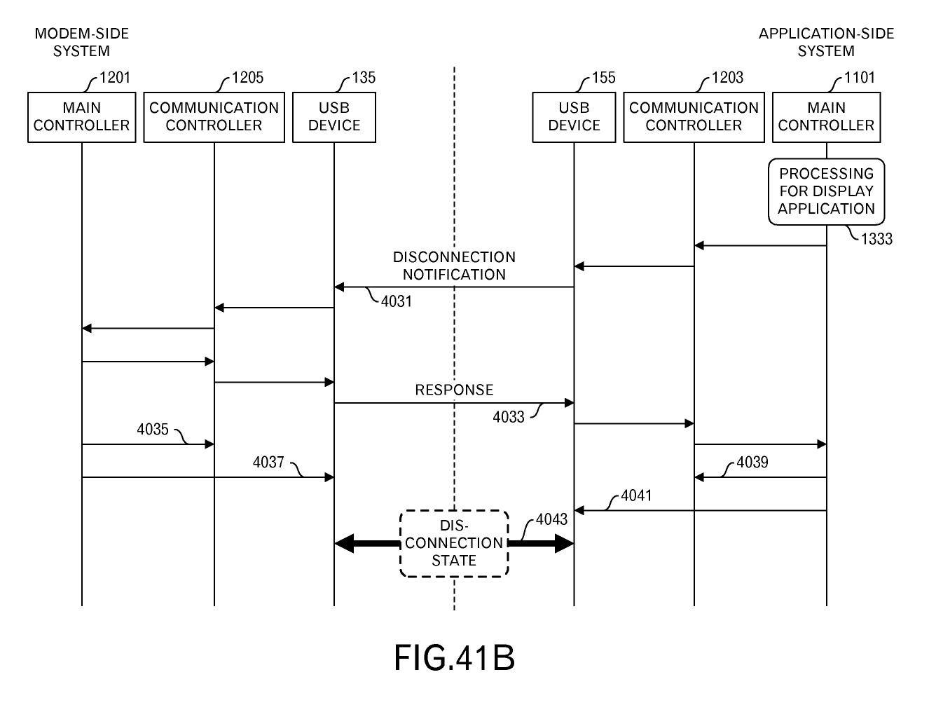

Next, a sequence when the RSSI event occurs in this embodiment will be explained by using FIG. 41A. It is assumed that the state of the CPU 151 of the application-side system 105 is the operational state 4101. The state of the CPU 131 of the modem-side system 103 is the operational state. When the RSSI event 4103 occurs, the main controller 1201 of the modem-side system 103 requests the measurement device 3903 of the application-side system 105 for the measurement through the measurement device 3905 of the modem-side system 103.

The measurement device 3903 of the application-side system 105 measures the value of the current inputted into the CPU 151 of the application-side system 105, and determines the state of the CPU 151 of the application-side system 105. Then, the measurement device 3903 informs the main controller 1201 of the modem-side system 103 of a measurement result representing whether the state of the CPU 151 of the application-side system 105 is operating or suspended, through the measurement device 3905 as illustrated by an arrow 4107.

The main controller 1201 of the modem-side system 103 examines the event that occurred and the state of the CPU 151 of the application-side system 105 (4109). Here, when the RSSI event occurs, and the state of the CPU 151 of the application-side system 105 is the operational state, “notification required” is set as the examination result (i.e. determination result). In the following, a sequence when the RSSI event occurs and the state of the CPU 151 of the application-side system 105 is the operational state will be explained.

As illustrated by an arrow 4111, the main controller 1201 of the modem-side system 103 switches the signal level of the first signal line 191 to HIGH through the output terminal 171 of the modem-side system 103. This is an interrupt signal for resuming the CPU 151 of the application-side system 105 from the suspended state to the operational state. However, because the CPU 151 of the application-side system 105 is already operating, this signal does not function substantially.

As illustrated by an arrow 4113, the main controller 1101 of the application-side system 105 detects the signal level of the first signal line 191 is HIGH through the input terminal 181 of the application-side system 105. However, because the CPU 151 of the application-side system 105 has already been operating, no particular processing is performed.

As illustrated by an arrow 4115, the main controller 1101 of the application-side system 105 switches the signal level of the second signal line 193 to HIGH through the output terminal 183 of the application-side system 105. This is an interrupt signal for resuming the CPU 131 of the modem-side system 103 from the suspended state to the operational state. However, because the CPU 131 of the modem-side system 103 is operating, the signal does not affect substantially.

As illustrated by an arrow 4117, the main controller 1201 of the modem-side system 103 detects the signal level of the second signal line 193 is HIGH through the input terminal 173 of the modem-side system 103. However, the CPU 131 of the modem-side system 103 has already been operating, so no particular processing is performed.

As illustrated by an arrow 4119, the main controller 1201 of the modem-side system 103 switches the signal level of the first signal line 191 to LOW through the output terminal 171 of the modem-side system 103. Thus, the interrupt signal outputted at the timing of the arrow 4111 is terminated.

As illustrated by an arrow 4121, when the main controller 1101 of the application-side system 105 detects the signal level of the first signal line 191 is switched to LOW through the input terminal 181 of the application-side system 105, the main controller 1101 of the application-side system 105 switches the signal level of the second signal line 193 to LOW through the output terminal 183 of the application-side system 105. Thus, the interrupt signal outputted at the timing of the arrow 4115 is terminated.

A sequence subsequent to the sequence illustrated in FIG. 41A is the same as the sequence illustrated in FIG. 13B. A sequence subsequent to the sequence illustrated in FIG. 13B will be explained by using FIG. 41B.

FIG. 41B illustrates a sequence when the RSSI event occurs in this embodiment. After completing the processing 1333 for the display application instead of the processing 1261 for the call application, which is illustrated in FIG. 40B, a sequence similar to the sequence illustrated in FIG. 40B is executed.

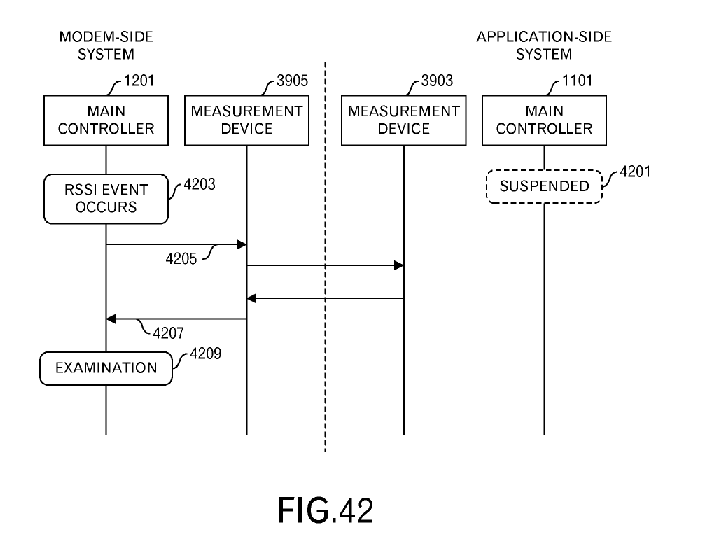

FIG. 42 illustrates a sequence when the CPU 151 of the application-side system 105 is suspended and the RSSI event occurs. It is assumed that the state of the CPU 151 of the application-side system 105 is the suspended state 4201. The state of the CPU 131 of the modem-side system 103 is the operational state.

When the RSSI event 4203 occurs, the main controller 1201 of the modem-side system 103 requests the measurement device 3903 of the application-side system 105 for the measurement through the measurement device 3905 of the modem-side system 103 as illustrated by an arrow 4205.

The measurement device 3903 of the application-side system 105 measures the value of the current inputted to the CPU 151 of the application-side system 105, and examines the state of the CPU 151 of the application-side system 105. Then, the measurement device 3903 sends the measurement result representing whether the state of the CPU 151 of the application-side system 105 is the operational state or the suspended state to the main controller 1201 of the modem-side system 103 through the measurement device 3905 as illustrated by an arrow 4207.

The main controller 1201 of the modem-side system 103 examines the event that occurred and the state of the CPU 151 of the application-side system 105 (4209). Here, because the RSSI event occurred and the state of the CPU 151 of the application-side system 105 is the suspended state, “notification not required” is set as the examination result (i.e. determination result). In this case, without resuming the CPU 151 of the application-side system 105 from the suspended state to the operational state, the processing ends.

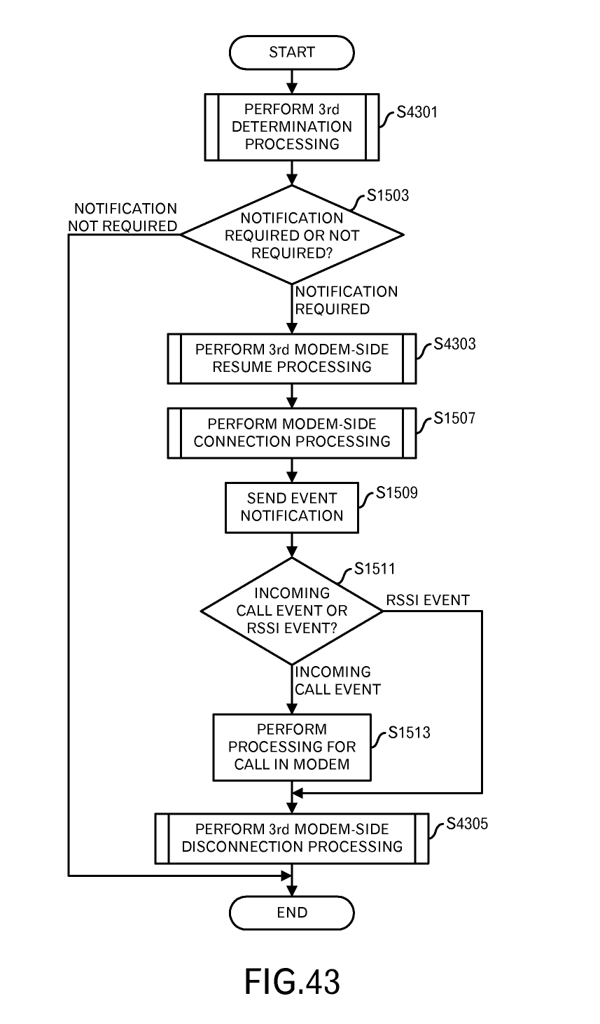

Next, a processing by the main controller 1201 of the modem-side system 103 in this embodiment will be explained by using FIG. 43. The main controller 1201 of the modem-side system 103 performs a third determination processing instead of the aforementioned first and second determination processing (S4301). The third determination processing corresponds to the examination 4005 illustrated in FIG. 40A, examination 4109 illustrated in FIG. 41A and determination 4209 illustrated in FIG. 42.

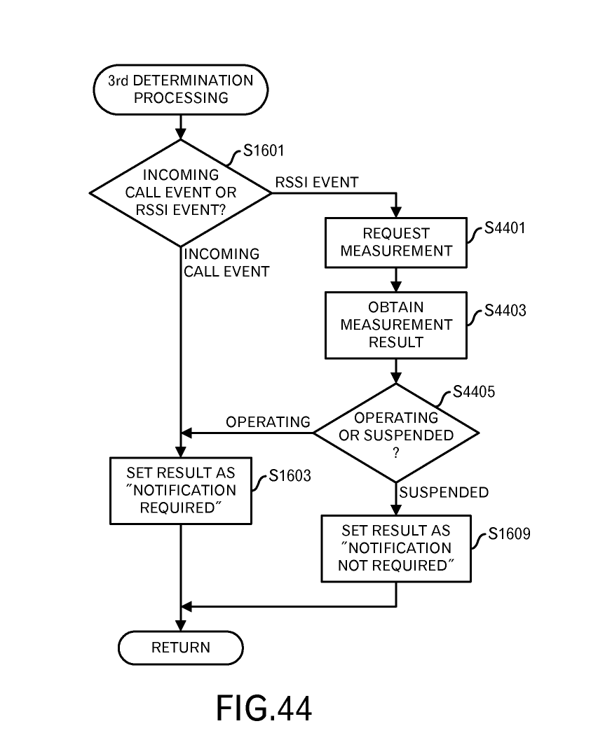

FIG. 44 illustrates a flow of the third determination processing. The main controller 1201 of the modem-side system 103 determines whether a type of the event that occurred is the incoming call event or RSSI event (S1601). When it is determined that the type of the event that occurred is the incoming call event, the main controller 1201 of the modem-side system 103 sets “notification required” as the determination result (i.e. examination result) (S1603).

On the other hand, when the type of the event that occurred is the RSSI event, the main controller 1201 of the modem-side system 103 requests the measurement device 3903 of the application-side system 105 for the measurement through the measurement device 3905 of the modem-side system 103 (S4401).

Then, the main controller 1201 of the modem-side system 103 obtains the measurement result from the measurement device 3903 of the application-side system 105 through the measurement device 3905 of the modem-side system 103 (S4403). The main controller 1201 of the modem-side system 103 determines whether the measurement result represents the CPU 151 is operating or being stopped (S4405). When it is determined that the measurement result represents the CPU 151 is operating, the main controller 1201 sets “notification required” as the determination result (i.e. examination result) (S1603). When it is determined that the measurement result represents the CPU 151 is being stopped, the main controller 1201 sets “notification not required” as the determination result (i.e. examination result) (S1609).

Returning to the processing in FIG. 43, the main controller 1201 of the modem-side system 103 branches off the processing depending on the determination result (S1503). When the determination result is “notification not required”, the processing ends. When the determination result is “notification required”, the main controller 1201 of the modem-side system 103 performs a third modem-side resume processing instead of the aforementioned first and second modem-side resume processing (S4303).

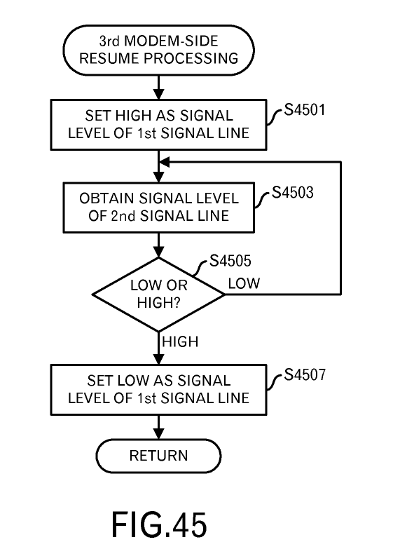

FIG. 45 illustrates a flow of the third modem-side resume processing. The main controller 1201 of the modem-side system 103 sets HIGH as the signal level of the first signal line 191 through the output terminal 171 (S4501). This corresponds to the arrow 4007 illustrated in FIG. 40A and the arrow 4111 illustrated in FIG. 41A.

The main controller 1201 of the modem-side system 103 obtains the signal level of the second signal line 193 through the input terminal 173 (S4503). The main controller 1201 of the modem-side system 103 determines whether the signal level of the second signal line 193 is HIGH or LOW (S4505). When it is determined that the signal level of the second signal line 193 is LOW, the processing returns to S4503. This processing is repeated until it is determined that the signal level of the second signal line 193 is HIGH. This corresponds to the arrow 4015 illustrated in FIG. 40A and the arrow 4117 illustrated in FIG. 41A.

The main controller 1201 of the modem-side system 103 sets LOW as the signal level of the first signal line 191 through the output terminal 171 (S4507). This corresponds to the arrow 4017 illustrated in FIG. 40A and the arrow 4119 illustrated in FIG. 41A.

Returning to the processing in FIG. 43, the main controller 1201 of the modem-side system 103 performs the modem-side connection processing (S1507). The modem-side connection processing (S1507) is the same as that explained by using FIG. 18. The main controller 1201 of the modem-side system 103 sends event notification (S1509). This corresponds to the arrow 1257 illustrated in FIG. 12B and the arrow 1331 illustrated in FIG. 13B.

The main controller 1201 of the modem-side system 103 determines whether a type of the notified event is the incoming call event or RSSI event (S1511). When it is determined that the type of the notified event is the incoming call event, the main controller 1201 of the modem-side system 103 performs the processing for call in modem (S1513). This corresponds to the processing 1263 for call in modem, which is illustrated in FIG. 12B.

When the processing for the call application by the main controller 1101 of the application-side system 105 ends, the main controller 1201 of the modem-side system 103 ends the processing for call in modem (S1513), and performs the third modem-side disconnection processing instead of the first modem-side disconnection processing (S1515) illustrated in FIG. 15 (S4305). When it is determined that the type of the notified event is the RSSI event, the third modem-side disconnection processing is executed. The third modem-side disconnection processing corresponds to the processing from the arrow 4031 to arrow 4037, which are illustrated in FIG. 40B and FIG. 41B.

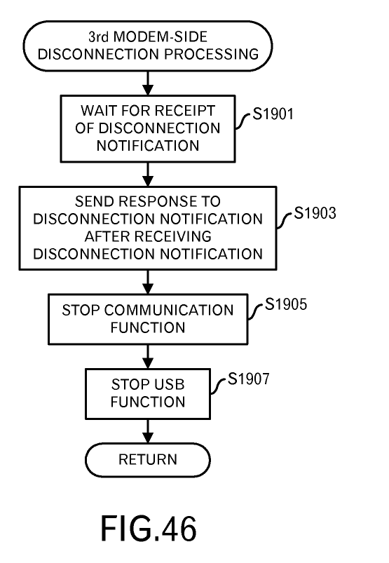

FIG. 46 illustrates a flow of the third modem-side disconnection processing. The main controller 1201 of the modem-side system 103 waits for receipt of the disconnection notification from the main controller 1101 of the application-side system 105 through the USB connection path (S1901). This corresponds to the arrow 4031 illustrated in FIGS. 40B and 41B.

After receiving the disconnection notification, the main controller 1201 of the modem-side system 103 transmits a response to the disconnection notification to the main controller 1101 of the application-side system 105 through the USB connection path (S1903). This corresponds to the arrow 4033 illustrated in FIG. 40B and FIG. 41B.

The main controller 1201 of the modem-side system 103 stops the connection function by the communication controller 1205 of the modem-side system 103. This corresponds to the arrow 4035 illustrated in FIG. 40B and FIG. 41B.

The main controller 1201 of the modem-side system 103 stops the USB function by the USB device 135 of the modem-side system 103 (S1907). This corresponds to the arrow 4037 illustrated in FIG. 40B and FIG. 41B.

When the third modem-side disconnection processing ends, the processing in FIG. 43 ends.

Next, a processing by the application-side system 105 will be explained. As illustrated in FIG. 40A, when the CPU 151 of the application-side system 105 detects the signal level of the first signal line 191 is HIGH through the input terminal 181 of the application-side system 105, the CPU 151 resumes from the suspended state to the operational state. In the following, the processing by the main controller 1101 of the application-side system 105 after the resume will be explained.

The processing by the main controller 1101 of the application-side system 105 in this embodiment will be explained. The main controller 1101 of the application-side system 105 performs a third application-side resume processing instead of the first application-side resume processing illustrated in FIG. 20 (S2001) (S4701). This corresponds to the processing from the arrow 4009 to arrow 4021, which are illustrated in FIG. 40A, and the processing from the arrow 4113 to arrow 4123, which are illustrated in FIG. 41A.

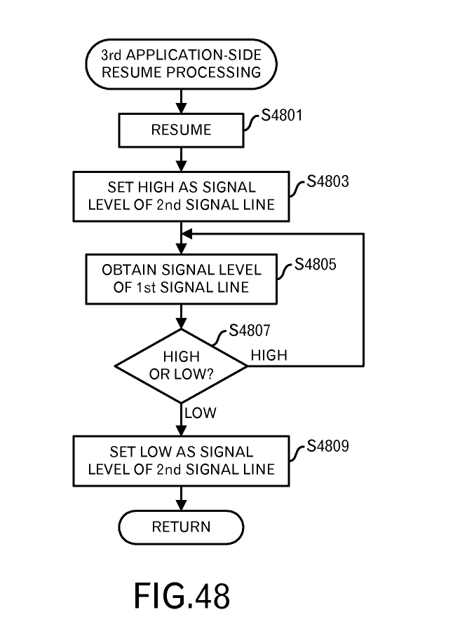

FIG. 48 illustrates a flow of the third application-side resume processing. The CPU 151 of the application-side system 105 resumes from the suspended state to the operational state in response to an interrupt signal (S4801). Specifically, when the CPU 151 of the application-side system 105 detects that the signal level of the first signal line 191 through the input terminal 181 of the application-side system 105 is HIGH, the CPU 151 determines that interrupt signal for the resume was received.

The main controller 1101 of the application-side system 105 sets HIGH as the signal level of the second signal line 193 through the output terminal 183 (S4803). This corresponds to the arrow 4013 illustrated in FIG. 40A and the arrow 4115 illustrated in FIG. 41A.

The main controller 1101 of the application-side system 105 obtains the signal level of the first signal line 191 through the input terminal 181 (S4805). The main controller 1101 of the application-side system 105 determines whether the signal level of the first signal line 191 is HIGH or LOW (S4807). When it is determined that the signal level of the first signal line 191 is HIGH, the processing returns to S4805. This processing is repeated until it is determined that the signal level of the first signal line 191 is LOW. This corresponds to the arrow 4019 illustrated in FIG. 40A and the arrow 4121 illustrated in FIG. 41A.

The main controller 1101 of the application-side system 105 sets LOW as the signal level of the second signal line 193 through the output terminal 183 (S4809). This corresponds to the arrow 4021 illustrated in FIG. 40A and the arrow 4123 illustrated in FIG. 41A.

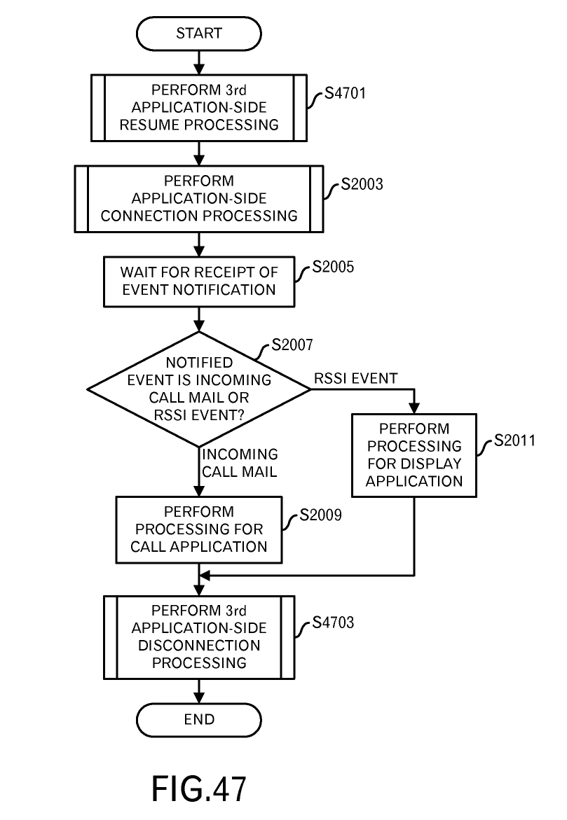

Returning to the processing in FIG. 47, the main controller 1101 of the application-side system 105 performs the application-side connection processing (S2003). This corresponds to the processing from the arrow 4031 to arrow 4041, which are illustrated in FIG. 40B and FIG. 41B. The application-side connection processing is the same as that explained by using FIG. 22.

The main controller 1101 of the application-side system 105 waits for receipt of the event notification (S2005). This corresponds to the arrow 4031 illustrated in FIG. 40B and FIG. 41B. After receiving the event notification the main controller 1101 of the application-side system 105 determines whether a type of the notified event is the incoming call event or the RSSI event (S2007). When it is determined that the type of the notified event is the incoming call event, the main controller 1101 of the application-side system 105 performs the processing for the call application (S2009). This corresponds to the processing 1261 for the call application, which is illustrated in FIG. 12B.

When it is determined that the type of the notified event is the RSSI event, the main controller 1101 of the application-side system 105 performs the processing for the display application (S2011). This corresponds to the processing 1333 for the display application, which is illustrated in FIG. 13B.

The main controller 1101 of the application-side system 105 performs a third application-side disconnection processing instead of the aforementioned first and second application-side disconnection processing (S4703). This corresponds to the processing from the arrow 4031 to arrow 4041, which are illustrated in FIG. 40B and FIG. 41B.

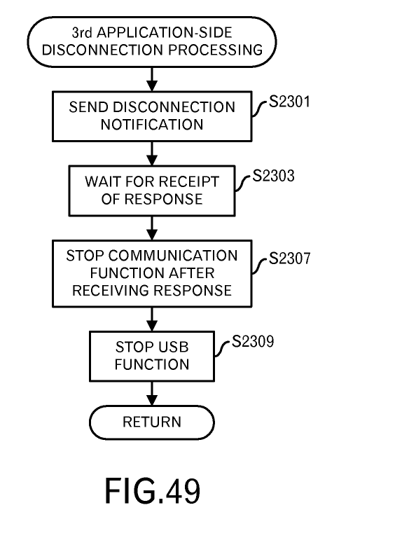

FIG. 49 illustrates a flow of the third application-side disconnection processing. The main controller 1101 of the application-side system 105 sends the disconnection notification to the main controller 1201 of the modem-side system 103 through the USB connection path (S2301). This corresponds to the arrow 4031 illustrated in FIG. 40B and FIG. 41B.

The main controller 1101 of the application-side system 105 waits for receipt of the response from the main controller 1201 of the modem-side system 103 through the USB connection path (S2303). This corresponds to the arrow 4033 illustrated In FIG. 40B and FIG. 41B.

After receiving the response, the main controller 1101 of the application-side system 105 stops the communication function by the communication controller 1203 of the application-side system 105 (S2307). This corresponds to the arrow 4039 illustrated in FIG. 40B and FIG. 41B.

The main controller 1101 of the application-side system 105 stops the USB function by the USB device 155 of the application-side system 105 (S2309). This corresponds to the arrow 4041 illustrated in FIG. 40B and FIG. 41B.

When the third application-side disconnection processing ends, the processing in FIG. 47 ends.

According to this embodiment, it is determined whether or not the application-side CPU is resumed to the operational state, based on the measurement result of the inputted current to the application-side CPU. Therefore, the notification regarding the state from the application-side CPU is not required, and the number of times of the resume of the modem-side CPU is reduced to suppress the power consumption.

In the aforementioned example, an example of the incoming call was explained, however, the embodiments may be applied to the mail arrival. In such a case, the main controller 1101 of the application-side system 105 may perform a processing for mail receiving application instead of the processing for the call application, which is illustrated in FIG. 12B. Moreover, instead of the call data illustrated in FIG. 12B, mail data regarding the received mail may be transmitted.

Although the embodiments of this technique were explained, these techniques are not limited to those. For example, the aforementioned functional block configuration do not always corresponds to a program module configuration.

Furthermore, as for the processing flow, as long as the processing results do not change, the turn of the steps may be exchanged. Furthermore, the steps may be executed in parallel.

The aforementioned embodiments are outlined as follows:

An information processing apparatus relating to a first aspect of the embodiments includes: a first processing unit (or arithmetic unit); and a second processing unit (or arithmetic unit) that is in either of an operational state and a suspended state. The first processing unit and the second processing unit are coupled each other by a first signal line through which a first signal that represents a state of the second processing unit passes and by a second signal line through which a second signal that causes an interrupt to the second processing unit passes. Then, the second processing unit outputs the first signal through the first signal line according to a state of the second processing unit. The first processing unit determines, based on the first signal received through the first signal line, whether or not the first processing unit causes the second processing unit to resume to the operational state, and upon determining that the first processing unit causes the second processing unit to resume to the operational state, the first processing unit outputs the second signal through the second signal line. The second processing unit resumes to the operational state, upon receiving the second signal through the second signal line.

With this configuration, in the information processing apparatus in which the first processing unit resumes the second processing unit depending on the state of the second processing unit, the first signal representing the state of the second processing unit is passed through the first signal line. Therefore, the number of times of the resume of a processing unit relating to the control among the plural processing units that are cooperating, and it is possible to suppress the power consumption.

Moreover, the first processing unit may perform a data communication processing with the second processing unit, when a first signal received before the data communication processing represents the operational state of the second processing unit. The first processing unit may determine that the second processing unit is not resumed to the operational state to omit the data communication processing, when the first signal received before the data communication processing represents the suspended state of the second processing unit.

With this configuration, when the second processing unit is operating, the data communication processing is performed, and when the second processing unit is suspended, the second processing unit is not resumed and the data communication is omitted. Therefore, it is possible to suppress the power consumption depending on the state of the second processing unit.

Moreover, the first signal line may be a signal line through which an interrupt signal that causes the first processing unit to resume to the operational state from the second processing unit to the first processing unit.

With this configuration, it is possible to inform the first processing unit of the state of the second processing unit, by using the signal line provided for informing the interrupt signal for resuming the first processing unit to the operational state by the second processing unit. Therefore, the number of signal lines is reduced, and the configuration of the information processing apparatus is simplified.

An information processing apparatus relating to a second aspect of the embodiments includes: a first processing unit; a second processing unit that is in either of an operational state and a suspended state; and a measurement device that measures an input current to the second processing unit and determines a state of the second processing unit. The first processing unit and the second processing unit are coupled each other by a signal line through which an interrupt signal to the second processing unit passes. Then, the first processing unit obtains a state of the second processing unit from the measurement device, and determines, based on the obtained state of the second processing unit, whether or not the first processing unit causes the second processing unit to resume to the operational state. Upon determining that the first processing unit causes the second processing unit to resume to the operational state, the first processing unit outputs the interrupt signal through the signal line. The second processing unit resumes to the operational state in response to receipt of the interrupt signal from the signal line.

With this configuration, in the information processing apparatus in which the first processing unit resumes the second processing unit depending on the state of the second processing unit, it is determined whether or not the second processing unit is resumed to the operational state, based on the measurement result of the input current into the second processing unit. Therefore, the number of times of the resume of a processing unit relating to the control among the plural processing units that are cooperating, and it is possible to suppress the power consumption.

Moreover, the first processing unit may perform a data communication processing with the second processing unit, when a state of the second processing unit, which was obtained before the data communication processing, is the operational state. In such a case, the first processing unit may determine that the first processing unit causes the second processing unit not to resume to the operational state to omit the data communication processing, when the state of the second processing unit, which was obtained before the data communication processing, is the suspended state.

With this configuration, when the second processing unit is operating, the data communication processing is performed, and when the second processing unit is suspended, the second processing unit is not resumed and the data communication is omitted. Therefore, it is possible to suppress the power consumption depending on the state of the second processing unit.

Furthermore, the first processing unit may connect with a wireless device. In such a case, the data communication processing may include a communication processing of data relating to measurement of radio field intensity by the wireless device, and the second processing unit may perform a processing based on the data relating to the measurement of the radio field intensity.

With this configuration, when the second processing unit is operating, the processing based on the data relating to the measurement of the radio field intensity is carried out, and when the second processing unit is suspended, the processing based on the data relating to the measurement of the radio field intensity is omitted. Therefore, it is possible to suppress the power consumption depending on the state of the second processing unit.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus comprising:
a first processing unit; and
a second processing unit that is in either of an operational state and a suspended state, and
wherein the first processing unit and the second processing unit are coupled each other by a first signal line through which a first signal that represents a state of the second processing unit passes and by a second signal line through which a second signal that causes an interrupt to the second processing unit passes,
the second processing unit outputs the first signal through the first signal line according to a state of the second processing unit,
the first processing unit determines, based on the first signal received through the first signal line, whether or not the first processing unit causes the second processing unit to resume to the operational state,
upon determining that the first processing unit causes the second processing unit to resume to the operational state, the first processing unit outputs the second signal through the second signal line, and
the second processing unit resumes to the operational state, upon receiving the second signal through the second signal line.

2. The information processing apparatus as set forth in claim 1, wherein the first processing unit performs a data communication processing with the second processing unit, when a first signal received before the data communication processing represents the operational state of the second processing unit, and
the first processing unit determines that the second processing unit is not resumed to the operational state to omit the data communication processing, when the first signal received before the data communication processing represents the suspended state of the second processing unit.

3. The information processing apparatus as set forth in claim 1, wherein the first signal line is a signal line through which an interrupt signal that causes the first processing unit to resume to the operational state from the second processing unit to the first processing unit.

4. An information processing apparatus comprising:
a first processing unit;
a second processing unit that is in either of an operational state and a suspended state; and
a measurement device that measures an input current to the second processing unit and determines a state of the second processing unit, and
wherein the first processing unit and the second processing unit are coupled each other by a signal line through which an interrupt signal to the second processing unit passes,
the first processing unit obtains a state of the second processing unit from the measurement device, and determines, based on the obtained state of the second processing unit, whether or not the first processing unit causes the second processing unit to resume to the operational state,
upon determining that the first processing unit causes the second processing unit to resume to the operational state, the first processing unit outputs the interrupt signal through the signal line, and
the second processing unit resumes to the operational state in response to receipt of the interrupt signal from the signal line.

5. The information processing apparatus as set forth in claim 4, wherein the first processing unit performs a data communication processing with the second processing unit, when a state of the second processing unit, which was obtained before the data communication processing, is the operational state, and
the first processing unit determines that the first processing unit causes the second processing unit not to resume to the operational state to omit the data communication processing, when the state of the second processing unit, which was obtained before the data communication processing, is the suspended state.

6. The information processing apparatus as set forth in claim 2, wherein the first processing unit connects with a wireless device,
the data communication processing includes a communication processing of data relating to measurement of radio field intensity by the wireless device, and
the second processing unit performs a processing based on the data relating to the measurement of the radio field intensity.

7. A control method, comprising:
outputting, by a first processing unit included in an information processing apparatus, a first signal through a first signal line according to a state of the first processing unit, wherein the information processing further includes a second processing unit, the first processing unit is in either of an operational state and a suspended state, and the first processing unit and the second processing unit are coupled each other by the first signal line through which the first signal that represents a state of the first processing unit passes and by a second signal line through which a second signal that causes an interrupt to the first processing unit passes;
determining, by the second processing unit and based on the first signal received through the first signal line, whether or not the second processing unit causes the first processing unit to resume to the operational state;
upon determining that the second processing unit causes the first processing unit to resume to the operational state, outputting, by the second processing unit, the second signal through the second signal line; and
resuming the first processing unit to the operational state, upon receiving the second signal through the second signal line.

8. A control method, comprising:
obtaining, by a first processing unit included in an information processing apparatus, a state of a second processing unit that is included in the information processing apparatus, from a measurement device that is included in the information processing apparatus, wherein the second processing unit is in either of an operational state and a suspended state, and the measurement device measures an input current to the second processing unit and determines a state of the second processing unit, and the first processing unit and the second processing unit are coupled each other by a signal line through which an interrupt signal to the second processing unit passes;
determining, by the first processing unit and based on the obtained state of the second processing unit, whether or not the first processing unit causes the second processing unit to resume to the operational state;
upon determining that the first processing unit causes the second processing unit to resume to the operational state, outputting, by the first processing unit, the interrupt signal through the signal line; and
resuming the second processing unit to the operational state in response to receipt of the interrupt signal from the signal line.
